(19) United States
(12) Patent Application Publication
(10) Pub. No.: US 2022/0352947 A1
(43) Pub. Date: Nov. 3, 2022

(54) METHOD AND APPARATUS FOR CSI REPORTING BASED ON COMBINING COEFFICIENTS

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 17/716,910

(22) Filed: Apr. 8, 2022

Related U.S. Application Data
(60) Provisional application No. 63/274,345, filed on Nov. 1, 2021.
(60) Provisional application No. 63/174,915, filed on Apr. 14, 2021.
(60) Provisional application No. 63/178,994, filed on Apr. 23, 2021.
(60) Provisional application No. 63/194,011, filed on May 27, 2021.
(60) Provisional application No. 63/208,319, filed on Jun. 8, 2021.
(60) Provisional application No. 63/234,996, filed on Aug. 19, 2021.
(60) Provisional application No. 63/257,833, filed on Oct. 20, 2021.

(51) Int. Cl. H04B 7/06

(52) U.S. Cl. CPC H04B 7/0626; H04B 7/0634; H04B 7/063

(57) ABSTRACT

A method for operating a user equipment (UE) comprises receiving information about a channel state information (CSI) report, the information including information about two parameters for basis vectors, N and M; determining n₃⁽⁰⁾ . . . n₃^{(M-1)}, wherein n₃⁽⁰⁾ . . . n₃^{(M-1)} are indices of M basis vectors selected from N basis vectors; determining nonzero offsets between the index n₃⁽⁰⁾ and indices n₃⁽¹⁾ . . . n₃^{(M-1)}; and transmitting the CSI report including an indicator i_{1,6} indicating the nonzero offsets between n₃⁽⁰⁾and the indices n₃⁽¹⁾ . . . n₃^{(M-1)}.

### CROSS-REFERENCE TO RELATED APPLICATIONS AND CLAIM OF PRIORITY

The present application claims priority to U.S. Provisional Patent Application No. 63/174,915, filed on Apr. 14, 2021; U.S. Provisional Patent Application No. 63/178,994, filed on Apr. 23, 2021; U.S. Provisional Patent Application No. 63/194,011, filed on May 27, 2021; U.S. Provisional Patent Application No. 63/208,319, filed on Jun. 8, 2021, U.S. Provisional Patent Application No. 63/234,996, filed on Aug. 19, 2021; U.S. Provisional Patent Application No. 63/257,833, filed on Oct. 20, 2021; and U.S. Provisional Patent Application No. 63/274,345, filed on Nov. 1, 2021. The content of the above-identified patent documents is incorporated herein by reference.

### TECHNICAL FIELD

The present disclosure relates generally to wireless communication systems and more specifically to CSI reporting based on combining coefficients.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE.

### SUMMARY

Embodiments of the present disclosure provide methods and apparatuses to enable channel state information (CSI) reporting in a wireless communication system.

In one embodiment, a UE for CSI reporting in a wireless communication system is provided. The UE includes a transceiver configured to: receive information about a CSI report, the information including information about two parameters for basis vectors, N and M. The UE further includes a processor operably connected to the transceiver. The processor is configured to: determine n₃⁽⁰⁾ . . . n₃^{(M-1)}, wherein n₃⁽⁰⁾ . . . n₃^{(M-1)} are indices of M basis vectors selected from N basis vectors; and determine nonzero offsets between n₃⁽⁰⁾ and n₃⁽¹⁾ . . . n₃^{(M-1)}. The transceiver is further configured to transmit the CSI report including an indicator i_{1,6} indicating the nonzero offsets between n₃⁽⁰⁾ and n₃⁽¹⁾ . . . n₃^{(M-1)}.

In another embodiment, a BS in a wireless communication system is provided. The BS includes a processor configured to generate information about a CSI report, the information including information about two parameters for basis vectors, N and M. The BS further includes a transceiver operably connected to the processor. The transceiver is configured to: transmit the information; and receive the CSI report; wherein the CSI report includes an indicator i_{1,6} indicating nonzero offsets between n₃⁽⁰⁾ . . . n₃^{(M-1)}, wherein n₃⁽⁰⁾ . . . n₃^{(M-1)} are indices of M basis vectors selected from N basis vectors.

In yet another embodiment, a method for operating a UE is provided. The method comprises: receiving information about a CSI report, the information including information about two parameters for basis vectors, N and M; determining n₃⁽⁰⁾ . . . n₃^{(M-1)}, wherein n₃⁽⁰⁾ . . . n₃^{(M-1)} are indices of M basis vectors selected from N basis vectors; determining nonzero offsets between n₃⁽⁰⁾ and n₃⁽¹⁾ . . . n₃^{(M-1)}; and transmitting the CSI report including an indicator i_{1,6} indicating the nonzero offsets between n₃⁽⁰⁾and n₃⁽¹⁾ . . . n₃^{(M-1)}).

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates an antenna port layout according to embodiments of the present disclosure;

FIG. 11 illustrates a 3D grid of oversampled DFT beams according to embodiments of the present disclosure;

FIG. 12 illustrates an example of a port selection codebook that facilitates independent (separate) port selection across SD and FD, and that also facilitates joint port selection across SD and FD according to embodiments of the present disclosure;

FIG. 13 illustrates a flow chart of a method for operating a UE according to embodiments of the present disclosure; and

FIG. 14 illustrates a flow chart of a method for operating a BS according to embodiments of the present disclosure.

### DETAILED DESCRIPTION

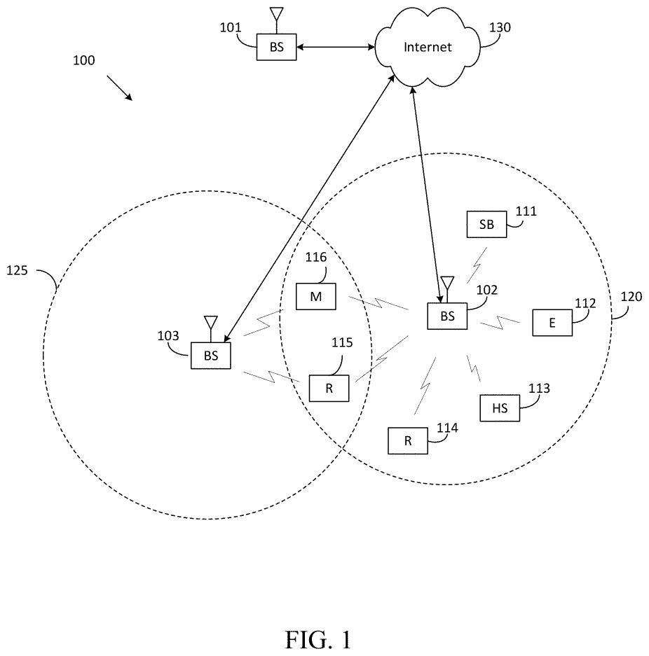

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.7.0, “E-UTRA, Radio Resource Control (RRC) protocol specification” (herein “REF 5”); 3GPP TR 22.891 v1.2.0 (herein “REF 6”); 3GPP TS 38.212 v17.0.0, “E-UTRA, NR, Multiplexing and channel coding” (herein “REF 7”); and 3GPP TS 38.214 v17.0.0, “E-UTRA, NR, Physical layer procedures for data” (herein “REF 8”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems, efforts have been made to develop an improved 5G or pre-5G communication system. Therefore, the 5G or pre-5G communication system is also called a “beyond 4G network” or a “post LTE system.”

The 5G communication system is considered to be implemented in higher frequency (mmWave) bands, e.g., 60 GHz bands, so as to accomplish higher data rates or in lower frequency bands, such as below 6 GHz, to enable robust coverage and mobility support. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, development for system network improvement is under way based on advanced small cells, cloud radio access networks (RANs), ultra-dense networks, device-to-device (D2D) communication, wireless backhaul communication, moving network, cooperative communication, coordinated multi-points (CoMP) transmission and reception, interference mitigation and cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another, or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving information about a channel state information (CSI) report, the information including information about two parameters for basis vectors, N and M; determining n₃⁽⁰⁾ . . . n₃^{(M-1)}, wherein n₃⁽⁰⁾ . . . n₃^{(M-1)} are indices of M basis vectors selected from N basis vectors; determining nonzero offsets between n₃⁽⁰⁾ and n₃⁽¹⁾ . . . n₃^{(M-1)}; and transmitting the CSI report including an indicator i_{1,6} indicating the nonzero offsets between n₃⁽⁰⁾ and n₃⁽¹⁾ . . . n₃^{(M-1)}. One or more of the gNBs 101-103 includes circuitry, programing, or a combination thereof, for generating information about a channel state information (CSI) report, the information including information about two parameters for basis vectors, N and M; transmitting the information; and receiving the CSI report; wherein the CSI report includes an indicator i_{1,6} indicating nonzero offsets between n₃⁽⁰⁾ and n₃⁽¹⁾ . . . n₃^{(M-1)}, wherein n₃⁽⁰⁾ . . . n₃^{(M-1)} are indices of M basis vectors selected from N basis vectors.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

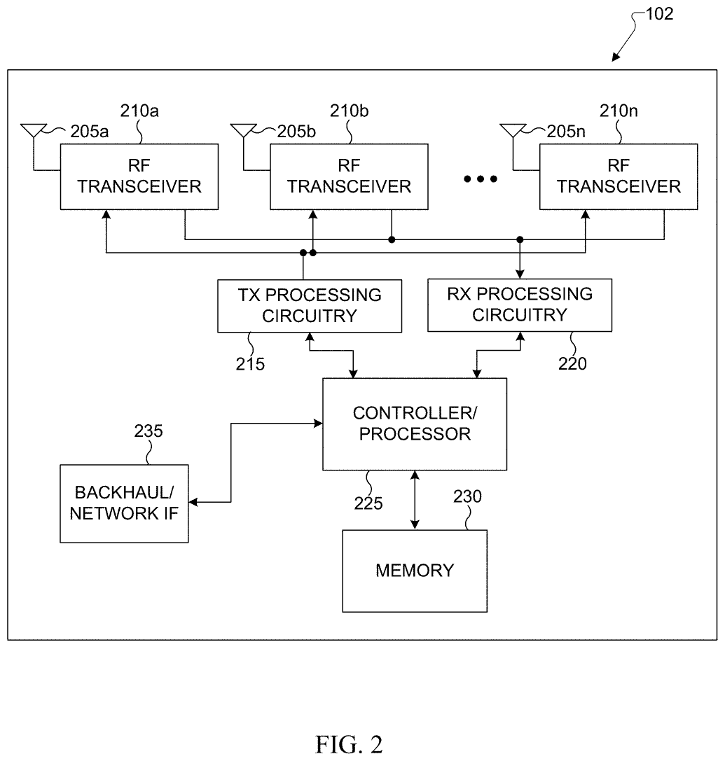

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

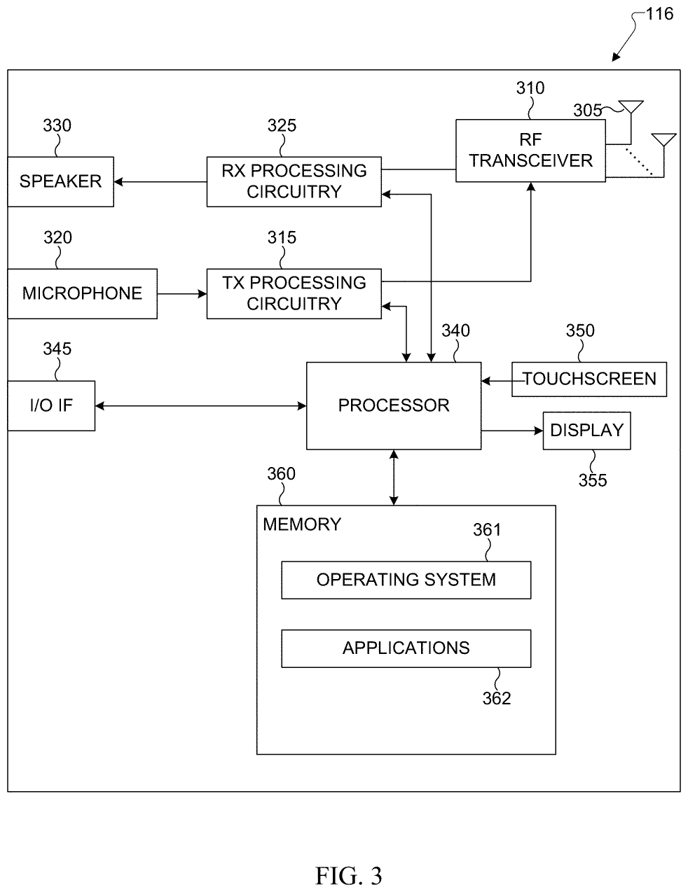

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving information about a channel state information (CSI) report, the information including information about two parameters for basis vectors, N and M; determining n₃⁽⁰⁾ . . . n₃^{(M-1)}, wherein n₃⁽⁰⁾ . . . n₃^{(M-1)} are indices of M basis vectors selected from N basis vectors; determining nonzero offsets between n₃⁽⁰⁾ and n₃⁽¹⁾ . . . n₃^{(M-1)}; and transmitting the CSI report including an indicator i_{1,6} indicating the nonzero offsets between n₃⁽⁰⁾ and n₃⁽¹⁾ . . . n₃^{(M-1)}. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

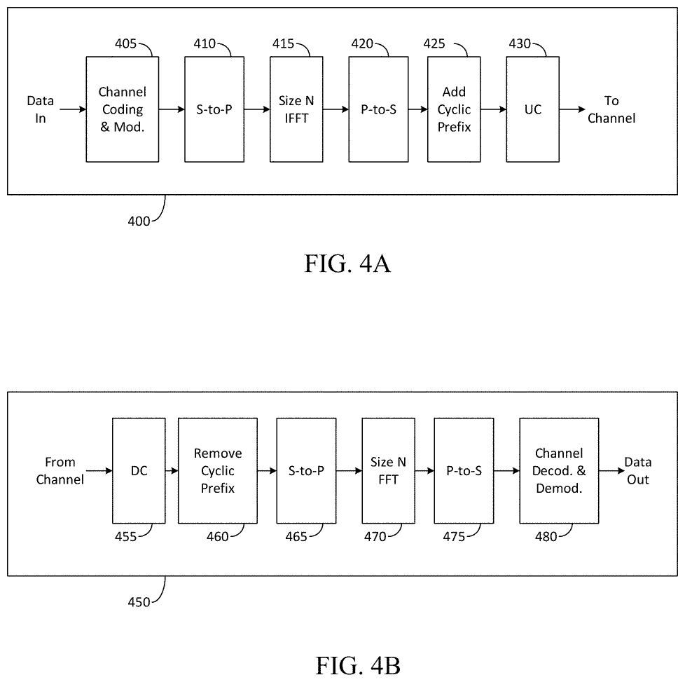

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460, and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

5G communication system use cases have been identified and described. Those use cases can be roughly categorized into three different groups. In one example, enhanced mobile broadband (eMBB) is determined to do with high bits/sec requirement, with less stringent latency and reliability requirements. In another example, ultra reliable and low latency (URLL) is determined with less stringent bits/sec requirement. In yet another example, massive machine type communication (mMTC) is determined that a number of devices can be as many as 100,000 to 1 million per km2, but the reliability/throughput/latency requirement could be less stringent. This scenario may also involve power efficiency requirement as well, in that the battery consumption may be minimized as possible.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe includes two slots. Each slot includes N_{symb}^{UL} symbols for transmitting data information, UCI, DMRS, or SRS. A frequency resource unit of an UL system BW is an RB. A UE is allocated N_{RB} RBs for a total of N_{RB}·N_{sc}^{RB} REs for a transmission BW. For a PUCCH, N_{RB}=1. A last subframe symbol can be used to multiplex SRS transmissions from one or more UEs. A number of subframe symbols that are available for data/UCI/DMRS transmission is N_{symb}=2·(N_{symb}^{UL}−1)−N_{SRS}, where N_{SRS}=1 if a last subframe symbol is used to transmit SRS and N_{SRS}=0 otherwise.

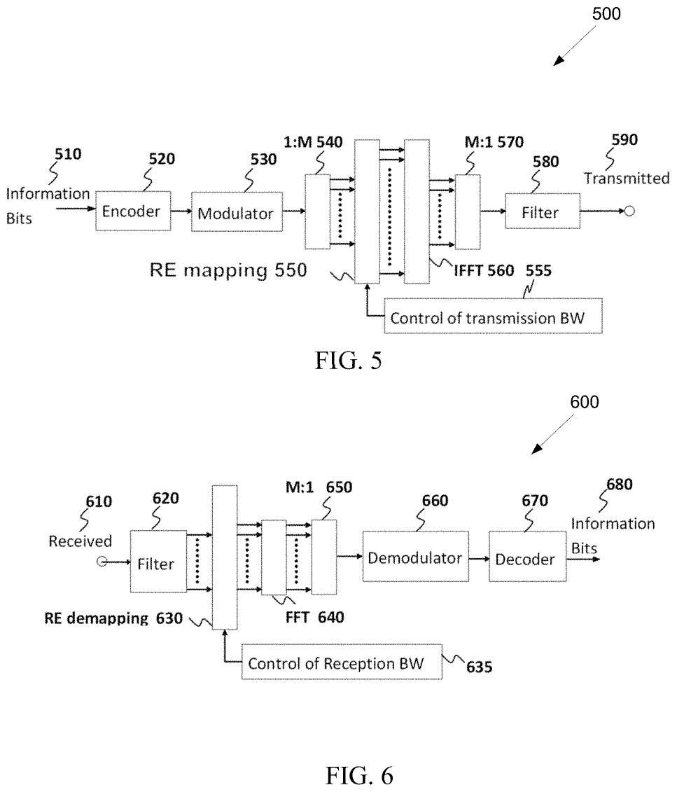

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

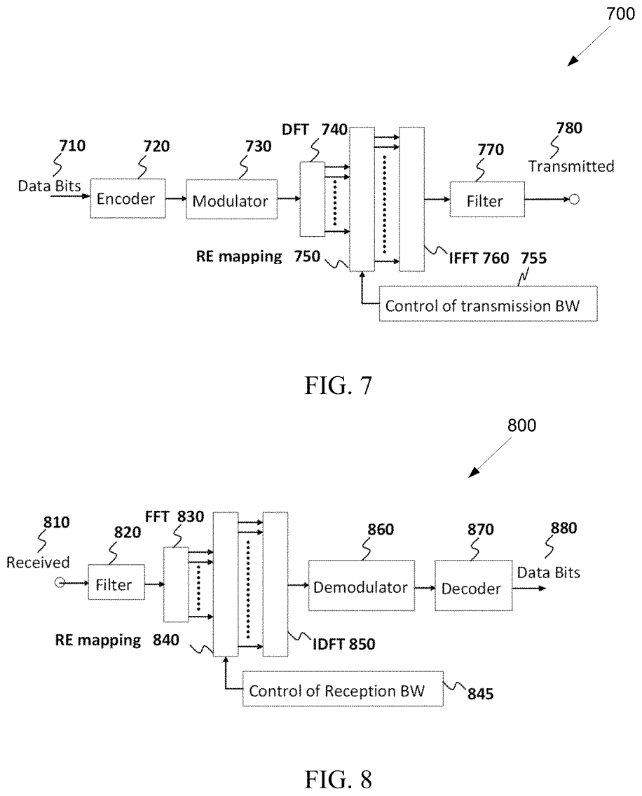

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies an FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

In next generation cellular systems, various use cases are envisioned beyond the capabilities of LTE system. Termed 5G or the fifth generation cellular system, a system capable of operating at sub-6 GHz and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km² with less stringent the reliability, data rate, and latency requirements.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

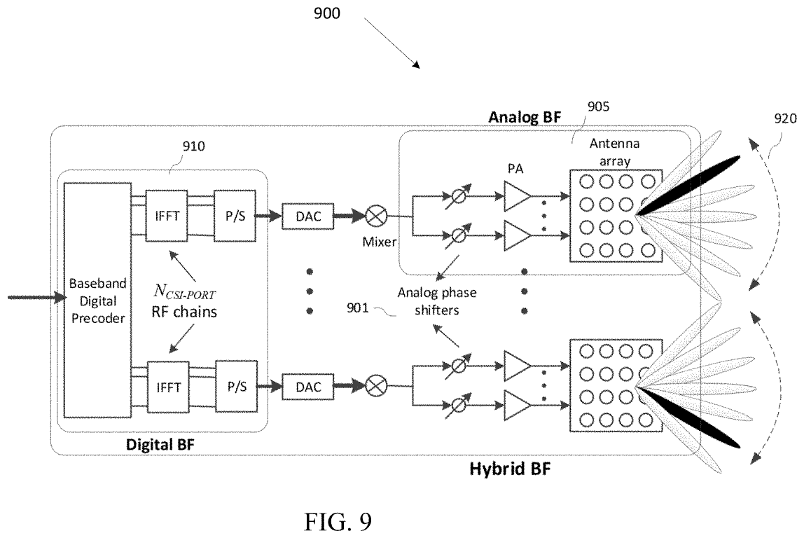

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported, for example, “CLASS A” CSI reporting which corresponds to non-precoded CSI-RS, “CLASS B” reporting with K=1 CSI-RS resource which corresponds to UE-specific beamformed CSI-RS, and “CLASS B” reporting with K>1 CSI-RS resources which corresponds to cell-specific beamformed CSI-RS.

For non-precoded (NP) CSI-RS, a cell-specific one-to-one mapping between CSI-RS port and TXRU is utilized. Different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (e.g., comprising multiple ports). At least at a given time/frequency, CSI-RS ports have narrow beam widths and hence not cell wide coverage, and at least from the gNB perspective. At least some CSI-RS port-resource combinations have different beam directions.

In scenarios where DL long-term channel statistics can be measured through UL signals at a serving eNodeB, UE-specific BF CSI-RS can be readily used. This is typically feasible when UL-DL duplex distance is sufficiently small. When this condition does not hold, however, some UE feedback is necessary for the eNodeB to obtain an estimate of DL long-term channel statistics (or any of representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In the 3GPP LTE specification, MIMO has been identified as an essential feature in order to achieve high system throughput requirements and it will continue to be the same in NR. One of the key components of a MIMO transmission scheme is the accurate CSI acquisition at the eNB (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, the CSI can be acquired using the CSI-RS transmission from the eNB, and CSI acquisition and feedback from the UE. In legacy FDD systems, the CSI feedback framework is ‘implicit’ in the form of CQI/PMI/RI derived from a codebook assuming SU transmission from the eNB. Because of the inherent SU assumption while deriving CSI, this implicit CSI feedback is inadequate for MU transmission. Since future (e.g., NR) systems are likely to be more MU-centric, this SU-MU CSI mismatch will be a bottleneck in achieving high MU performance gains. Another issue with implicit feedback is the scalability with larger number of antenna ports at the eNB. For large number of antenna ports, the codebook design for implicit feedback is quite complicated, and the designed codebook is not guaranteed to bring justifiable performance benefits in practical deployment scenarios (for example, only a small percentage gain can be shown at the most).

In 5G or NR systems, the above-mentioned CSI reporting paradigm from LTE is also supported and referred to as Type I CSI reporting. In addition to Type I, a high-resolution CSI reporting, referred to as Type II CSI reporting, is also supported to provide more accurate CSI information to gNB for use cases such as high-order MU-MIMO. The overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of P_{CSI-RS}/2 CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

It has been known in the literature that UL-DL channel reciprocity exists in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD and/or M ports are selected in FD. The CSI-RS ports in this case are beamformed in SD (assuming UL-DL channel reciprocity in angular domain) and/or FD (assuming UL-DL channel reciprocity in delay/frequency domain), and the corresponding SD and/or FD beamforming information can be obtained at the gNB based on UL channel estimated using SRS measurements. This disclosure provides some of design components of such a codebook.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

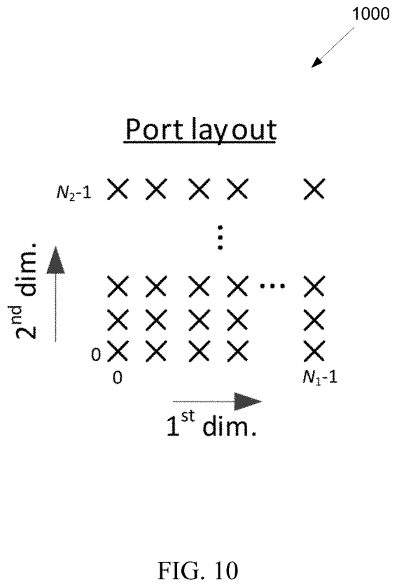

FIG. 10 illustrates an example antenna port layout 1000 according to embodiments of the present disclosure. The embodiment of the antenna port layout 1000 illustrated in FIG. 10 is for illustration only. FIG. 10 does not limit the scope of this disclosure to any particular implementation of the antenna port layout 1000.

As illustrated in FIG. 10, N₁ and N₂ are the number of antenna ports with the same polarization in the first and second dimensions, respectively. For 2D antenna port layouts, N₁>1, N₂>1, and for 1D antenna port layouts N₁>1 and N₂₌₁. Therefore, for a dual-polarized antenna port layout, the total number of antenna ports is 2N₁N₂.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include a frequency dimension in addition to the first and second antenna port dimensions.

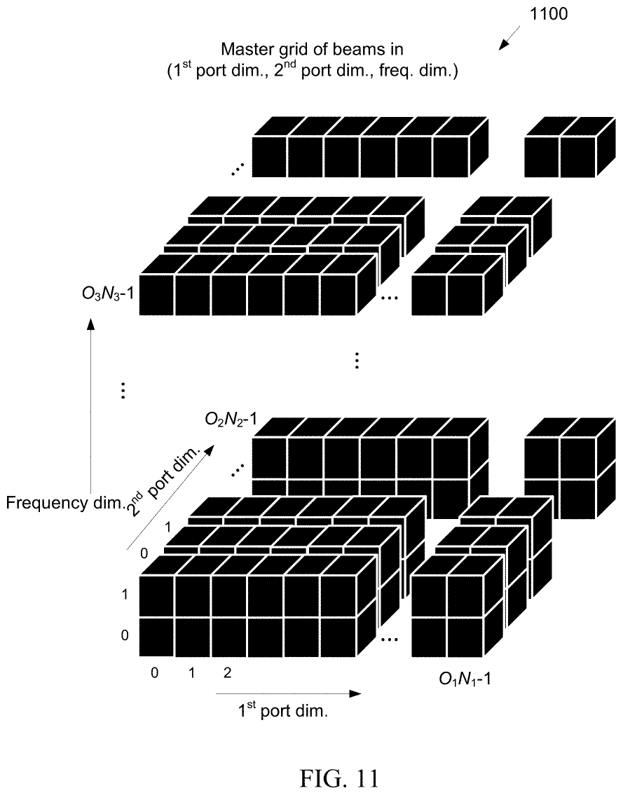

FIG. 11 illustrates a 3D grid 1100 of the oversampled DFT beams (1st port dim., 2nd port dim., freq. dim.) in which
1st dimension is associated with the 1st port dimension,
2nd dimension is associated with the 2nd port dimension, and
3rd dimension is associated with the frequency dimension.
   The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$${W}^{l} = A {C}_{l} {B}^{H} = {[ {a}_{0} {a}_{1} … {a}_{L - 1} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] [ {b}_{0} {b}_{1} … {b}_{M - 1} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = {[ \begin{matrix}{a}_{0} {a}_{1} … {a}_{L - 1} & 0 \\ 0 & {a}_{0} {a}_{1} … {a}_{L - 1}\end{matrix} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] [ {b}_{0} {b}_{1} … {b}_{M - 1} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, and aᵢ is a N₁N₂×1 or

$$\frac{{P}_{CSIRS}}{2} \times 1$$

port selection column vector if antenna ports at the gNB are co-polarized, and is a 2N₁N₂×1 or P_{CSIRS}×1 port selection column vector if antenna ports at the gNB are dual-polarized or cross-polarized, where a port selection vector is a defined as a vector which contains a value of 1 in one element and zeros elsewhere, and P_{CSIRS} is the number of CSI-RS ports configured for CSI reporting,
b_{f} is a N₃×1 column vector,
c_{l,i,f} is a complex coefficient associate with vectors aᵢ and b_{f}.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of this disclosure.
x_{l,i,f}=0 otherwise (i.e., c_{l,i,f} is not reported by the UE).
   The indication whether x_{l,i,f}=1 or 0 is according to some embodiments of this disclosure. For example, it can be via a bitmap.

In a variation, the precoder equations Eq. 1 or Eq. 2 are respectively generalized to

W^{l}=Σᵢ₌₀^{L-1}Σ_{f=0}^{M}^{ᵢ}⁻¹c_{l,i,f}(aᵢb_{i,f}^{H}) (Eq. 3)

and

$${W}^{l} = [ \begin{matrix}{\sum }_{i = 0}^{L - 1} {\sum }_{f = 0}^{{M}_{i} - 1} & {c}_{l , i , f} ( {a}_{i} {b}_{i , f}^{H} ) \\ {\sum }_{i = 0}^{L - 1} {\sum }_{= 0}^{{M}_{i} - 1} & {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or E Mᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & ⋯ & {W}^{R} ] .\end{matrix}$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & ⋯ & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , v} (where v is the RI or rank value) is given by

$${w}_{f} = {[ \begin{matrix}{y}_{0 , l}^{( f )} & {y}_{1 , l}^{( f )} & ⋯ & {y}_{{N}_{3} - 1 , l}^{( f )}\end{matrix} ]}^{T} , where {y}_{t , l}^{( f )} = {e}^{j \frac{2 π {tn}_{3 , l}^{( f )}}{{N}_{3}}} and {n}_{3 , l} = [ {n}_{3 , l}^{( 0 )} , … , {n}_{3 , l}^{( M - 1 )} ] where {n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by

$${[ {W}_{f} ]}_{nm} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} ,$$

and K=N₃, and m=0, . . . ,N₃−1.

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

W=AₗCₗBₗ^{H}=W₁\tilde{W}₂W_{f}^{H}, (5)

where A=W₁ corresponds to the Rel. 15 W₁ in Type II CSI codebook [REF8], and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}ϕ_{1,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using an A1-bit amplitude codebook where A1 belongs to {2, 3, 4}, and p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.

The UE reports the following for the quantization of the NZ coefficients in \tilde{W}₂
A X-bit indicator for the strongest coefficient index (i*,f*), where X=┌log₂ K_{NZ}┐ or ┌log₂ 2L┐.
   Strongest coefficient c_{l,i*,f*}=1 (hence its amplitude/phase are not reported)
Two antenna polarization-specific reference amplitudes are used.
   For the polarization associated with the strongest coefficient c_{l,i*,f*}=1, since the reference amplitude p_{l,i,f}⁽¹⁾=1, it is not reported
   For the other polarization, reference amplitude pf is quantized to 4 bits
      The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i,f)≠(i*,f*)}:
   For each polarization, differential amplitudes p_{l,i,f}⁽²⁾ of the coefficients calculated relative to the associated polarization-specific reference amplitude and quantized to 3 bits
      The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: The final quantized amplitude p_{l,i,f} is given by p_{l,i,f}⁽¹⁾×p_{l,i,f}⁽²⁾
Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹=p_{l,r*}⁽¹⁾=1. For the other polarization r∈{0,1} and r≠r*, we have

$$r = ( ⌊ \frac{{i}^{*}}{L} ⌋ + 1 )$$

mod 2 ad the reference amplitude p_{l,i,f}⁽¹⁾=p_{l,r}⁽¹⁾ is quantized (reported) using the 4-bit amplitude codebook mentioned above.
A UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

In one example, the p value is higher-layer configured for rank 1-2 CSI reporting. For rank>2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} , i . e . , M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In the rest of the disclosure, M is replaced with Mᵥ to show its dependence on the rank value v, hence p is replaced with pᵥ, v∈{1,2} and v₀ is replaced with pᵥ, v∈{3,4}.

A UE can be configured to report Mᵥ FD basis vectors in one-step from N₃ basis vectors freely (independently) for each layer l∈{0, 1, . . . , v−1} of a rank v CSI reporting. Alternatively, a UE can be configured to report Mᵥ FD basis vectors in two-step as follows.
In step 1, an intermediate set (InS) comprising N₃′<N₃ basis vectors is selected/reported, wherein the InS is common for all layers.
In step 2, for each layer l∈{0, 1, . . . , v−1} of a rank v CSI reporting, M FD basis vectors are selected/reported freely (independently) from N₃′ basis vectors in the InS.

In one example, one-step method is used when N₃≤19 and two-step method is used when N₃>19. In one example, N₃′=┌αM┐ where α>1 is either fixed (to 2 for example) or configurable.

The codebook parameters used in the DFT based frequency domain compression (eq. 5) are (L, pᵥ for v∈{1,2}, pᵥ for v∈{3,4}, β, α, Nₚₕ). In one example, the set of values for these codebook parameters are as follows.
L: the set of values is {2,4} in general, except L∈{2, 4, 6} for rank 1-2, 32 CSI-RS antenna ports, and R=1.

$$\cdot ( {p}_{υ} for υ ∈ \{ 1 , 2 \} , {p}_{υ} for υ ∈ \{ 3 , 4 \} ∈ \{ ( \frac{1}{2} , \frac{1}{4} ) , ( \frac{1}{4} , \frac{1}{4} ) , ( \frac{1}{4} , \frac{1}{8} ) \} .$$

$$•β ∈ \{ \frac{1}{4} , \frac{1}{2} , \frac{3}{4} \} .$$

α∈{1.5,2,2.5,3}
Nₚₕ∈{8,16}.

In another example, the set of values for these codebook parameters are as follows: α=2, Nₚₕ=16, and as in Table 1, where the values of L, β and pᵥ are determined by the higher layer parameter paramCombination-r17. In one example, the UE is not expected to be configured with paramCombination-r17 equal to
3, 4, 5, 6, 7, or 8 when P_{CSI-RS}=4,
7 or 8 when number of CSI-RS ports P_{CSI-RS}<32,
7 or 8 when higher layer parameter typeII-RI-Restriction-r17 is configured with rᵢ=1 for any i>1,
7 or 8 when R=2.

The bitmap parameter typeII-RI-Restriction-r17 forms the bit sequence r₃, r₂, r₁, r₀ where r₀ is the LSB and r₃ is the MSB. When rᵢ is zero, i∈{0, 1, . . . ,3}, PMI and RI reporting are not allowed to correspond to any precoder associated with v=i+1 layers. The parameter R is configured with the higher-layer parameter numberOfPMISubbandsPerCQISubband-r17. This parameter controls the total number of precoding matrices N₃ indicated by the PMI as a function of the number of subbands in csi-ReportingBand, the subband size configured by the higher-level parameter subbandSize and of the total number of PRBs in the bandwidth part.

TABLE 1

| | | p_{υ} | | |
|---|---|---|---|---|
| | | υ | υ | |
| paramCombination-r17 | L | ϵ {1, 2} | ϵ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The above-mentioned framework (equation 5) represents the precoding-matrices for multiple (N₃) FD units using a linear combination (double sum) over 2L SD beams and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows.

W=AₗCₗBₗ^{H}=W₁\tilde{W}₂Wₜ^{H}, (equation 5A)

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

The rest of disclosure is applicable to both space-frequency (equation 5) and space-time (equation 5A) frameworks.

In general, for layer l=1, . . . , v, where v is the rank value reported via RI, the pre-coder (cf. equation 5 and equation 5A) includes some of or all of the codebook components summarized in Table 2.

TABLE 2
Codebook components

| Index | Components | Description |
|---|---|---|
| 0 | L | number of SD beams |
| 1 | M_{υ} | number of FD/TD beams |
| 2 | {aᵢ}ᵢ₌₀^{L-1} | set of SD beams comprising columns of Aₗ |
| 3 | {b_{l, ƒ}}_{ƒ=0}^{M}_{_{υ}}⁻¹ | set of FD/TD beams comprising columns of |
| | | Bₗ |
| 4 | {x_{l, i, ƒ}} | bitmap indicating the indices of the non-zero |
| | | (NZ) coefficients |
| 5 | SCIₗ | Strongest coefficient indicator for layer l |
| 6 | {p_{l, i, ƒ}} | amplitudes of NZ coefficients indicated via |
| | | the bitmap |
| 7 | {ϕ_{l, i, ƒ}} | phases of NZ coefficients indicated via the |
| | | bitmap |

Let P_{CSIRS,SD} and P_{CSIRS,FD} be number of CSI-RS ports in SD and FD, respectively. The total number of CSI-RS ports is P_{CSIRS,SD}×P_{CSIRS,FD}=P_{CSIRS}. Each CSI-RS port can be beam-formed/pre-coded using a pre-coding/beam-forming vector in SD or FD or both SD and FD. The pre-coding/beam-forming vector for each CSI-RS port can be derived based on UL channel estimation via SRS, assuming (partial) reciprocity between DL and UL channels. Since CSI-RS ports can be beam-formed in SD as well as FD, the Rel. 15/16 Type II port selection codebook can be extended to perform port selection in both SD and FD followed by linear combination of the selected ports. In the rest of the disclosure, some details pertaining to the port selection codebook for this extension are provided.

In the rest of disclosure, the terms ‘beam’ and ‘port’ are used interchangeably and they refer to the same component of the codebook. For brevity, beam/port or port/beam is used in this disclosure.

In one embodiment A.1, a UE is configured with higher layer parameter codebookType set to ‘typeII-PortSelection-r17’ for CSI reporting based on a new (Rel. 17) Type II port selection codebook in which the port selection (which is in SD) in Rel. 15/16 Type II port selection codebook is extended to FD in addition to SD. The UE is also configured with P_{CSIRS} CSI-RS ports (either in one CSI-RS resource or distributed across more than one CSI-RS resources) linked with the CSI reporting based on this new Type II port selection codebook. In one example, P_{CSIRS}=Q. In another example, P_{CSIRS}≥Q. Here, Q=P_{CSIRS,SD}×P_{CSIRS,FD}. The CSI-RS ports can be beamformed in SD or/and FD. The UE measures P_{CSIRS} (or at least Q) CSI-RS ports, estimates (beam-formed) DL channel, and determines a precoding matrix indicator (PMI) using the new port selection codebook, wherein the PMI indicates a set of components S that can be used at the gNB to construct precoding matrices for each FD unit t∈{0, 1, . . . , N₃−1} (together with the beamforming used to beamformed CSI-RS). In one example, P_{CSIRS,SD}∈{4, 8, 12, 16, 32} or {2,4,8,12,16,32}. In one example, P_{CSIRS,SD} and P_{CSIRS,FD} are such that their product Q=P_{CSIRS,SD}×P_{CSIRS,FD}∈{4,8,12,16,32} or {2,4,8,12,16,32}.

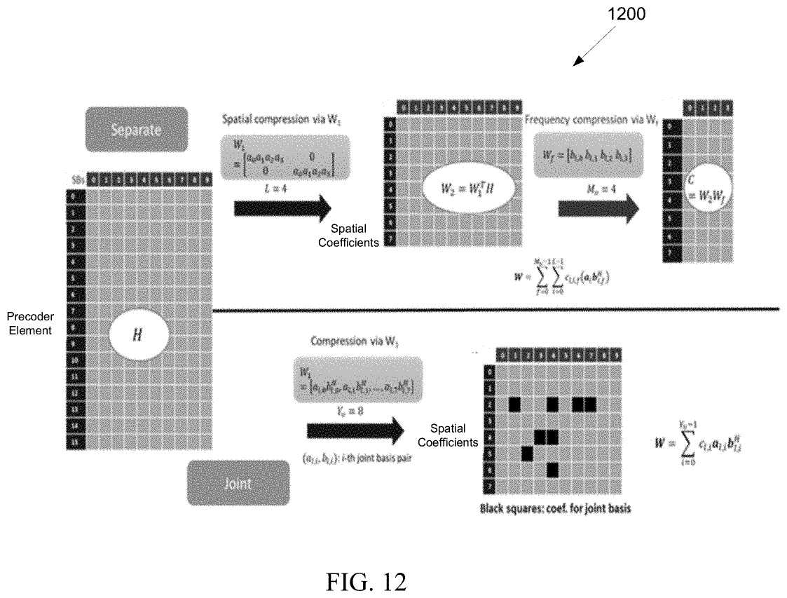

FIG. 12 illustrates an example of a new port selection codebook that facilitates independent (separate) port selection across SD and FD, and that also facilitates joint port selection across SD and FD 1200 according to embodiments of the disclosure. The embodiment of a new port selection codebook that facilitates independent (separate) port selection across SD and FD, and that also facilitates joint port selection across SD and FD 1200 illustrated in FIG. 12 is for illustration only. FIG. 12 does not limit the scope of this disclosure to any particular implementation of the example of a new port selection codebook that facilitates independent (separate) port selection across SD and FD, and that also facilitates joint port selection across SD and FD 1200.

The new port selection codebook facilitates independent (separate) port selection across SD and FD. This is illustrated in the top part of FIG. 12.

For layer l=1, . . . , v, where v is the rank value reported via RI, the pre-coder (cf. equation 5 and equation 5A) includes the codebook components (indicated via PMI) summarized in Table 3. The parameters L and Mᵢ are either fixed or configured (e.g., via RRC).

TABLE 3
Codebook components

| Index | Components | Description |
|---|---|---|
| 0 | {aᵢ}ᵢ₌₀^{L-1} | set of SD beams/ports comprising columns of Aₗ |
| 1 | {b_{l, ƒ}}_{ƒ=0}^{M}_{_{υ}}⁻¹ | set of FD/TD beams/ports comprising columns of |
| | | Bₗ |
| 2 | {x_{l, i, ƒ}} | bitmap indicating the indices of the non-zero (NZ) |
| | | coefficients |
| 3 | SCIₗ | an indicator indicating an index (iₗ*, ƒₗ*) of the |
| | | strongest coefficient for layer l |
| 4 | P_{l, r}⁽¹⁾ | reference amplitude |
| 5 | {p_{l, i, ƒ}} | amplitudes of NZ coefficients indicated via the |
| | | bitmap |
| 6 | {ϕ_{l, i, ƒ}} | phases of NZ coefficients indicated via the bitmap |

In one embodiment A.2, a UE is configured with higher layer parameter codebookType set to ‘typeII-PortSelection-r17’ for CSI reporting based on a new (Rel. 17) Type II port selection codebook in which the port selection (which is in SD) in Rel. 15/16 Type II port selection codebook is extended to FD in addition to SD. The UE is also configured with P_{CSIRS} CSI-RS ports (either in one CSI-RS resource or distributed across more than one CSI-RS resources) linked with the CSI reporting based on this new Type II port selection codebook. In one example, P_{CSIRS}=Q. In another example, P_{CSIRS}≥Q. Here, Q=P_{CSIRS,SD}×P_{CSIRS,FD}. The CSI-RS ports can be beamformed in SD or/and FD. The UE measures P_{CSIRS} (or at least Q) CSI-RS ports, estimates (beam-formed) DL channel, and determines a precoding matrix indicator (PMI) using the new port selection codebook, wherein the PMI indicates a set of components S that can be used at the gNB to construct precoding matrices for each FD unit t∈{0, 1, . . . , N₃−1} (together with the beamforming used to beamformed CSI-RS). In one example, P_{CSIRS,SD}∈{4,8,12,16,32} or {2, 4, 8, 12, 16, 32}. In one example, P_{CSIRS,SD} and P_{CSIRS,FD} are such that their product Q=P_{CSIRS,SD}×P_{CSIRS,FD}∈{4,8,12,16,32} or {2,4,8,12,16,32}.

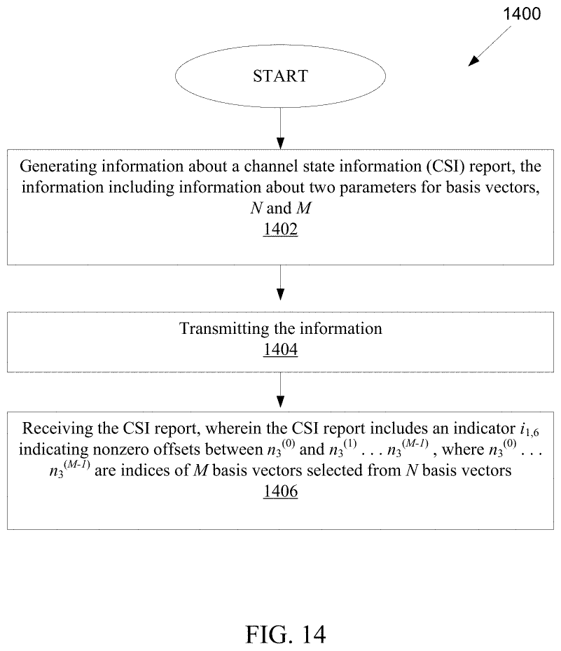

The new port selection codebook facilitates joint port selection across SD and FD. This is illustrated in the bottom part of FIG. 14. The codebook structure is similar to Rel. 15 NR Type II codebook comprising two main components.
W₁: to select Yᵥ out of P_{CSI-RS} SD-FD port pairs jointly
   In one example, Yᵥ≤P_{CSI-RS} (if the port selection is independent across two polarizations or two groups of antennas with different polarizations)
   In one example,

$${Y}_{υ} \leq \frac{{P}_{CSI - RS}}{2}$$

(if the port selection is common across two polarizations or two groups of antennas with different polarizations)
W₂: to select coefficients for the selected Yₙ SD-FD port pairs.

In one example, the joint port selection (and its reporting) is common across multiple layers (when v>1). In one example, the joint port selection (and its reporting) is independent across multiple layers (when v>1). The reporting of the selected coefficients is independent across multiple layers (when v>1).

For layer l=1, . . . , v, where v is the rank value reported via RI, the pre-coder (cf. equation 5 and equation 5A) includes the codebook components (indicated via PMI) summarized in Table 4. The parameter Yᵥ is either fixed or configured (e.g., via RRC).

TABLE 4
Codebook components

| Index | Components | Description |
|---|---|---|
| 0 | {(a_{l, i}, b_{l, i})}ᵢ₌₀^{Y}_{_{υ}}⁻¹ | set of selected (SD, FD/TD) beam/port pairs |
| | | comprising columns of Aₗ and Bₗ |
| 1 | {x_{l, i}} | bitmap indicating the indices of the non-zero |
| | | (NZ) coefficients |
| 2 | SCIₗ | an indicator indicating an index iₗ* of the |
| | | strongest coefficient for layer l |
| 3 | P_{l, r}⁽¹⁾ | reference amplitude |
| 4 | {p_{l, i}} | amplitudes of NZ coefficients indicated via |
| | | the bitmap |
| 5 | {ϕ_{l, i}} | phases of NZ coefficients indicated via the |
| | | bitmap |

In one embodiment I, a UE is configured with higher layer parameter codebookType set to ‘typeII-PortSelection-r17’ for CSI reporting based on a new (Rel. 17) Type II port selection codebook which has a component \tilde{W}₂ for coefficient amplitude/phase reporting (as described in embodiment A.1 and A.2′). For rank 1 (v=1′), the component \tilde{W}₂ comprises a total of Z=2LM₁ or K₁M₁ elements/coefficients (2L×M₁ or K₁×M₁ matrix), where M₁=number of FD basis vectors comprising columns of W_{f}, and 2L=K₁=number of ports selected via W₁.

When v>1, the component \tilde{W}₂ is independent for each layer l=1, . . . , v, and comprises Zᵥ=2LMᵥ or K₁Mₙ elements/coefficients (2L×Mₙ or K₁×Mₙ matrix), where Mᵥ number of FD basis vectors comprising columns of W_{f}. So, there are Z^{tot}=vZᵥ=v2LMᵥ or vK₁Mᵥ coefficients in total across all layers.

In one example, each coefficient is a product of a coefficient amplitude and a coefficient phase. For brevity, the term “coefficient” is used in to denote both “the coefficient amplitude and the coefficient phase” in the rest of the disclosure. Hence, coefficient reporting implies reporting of both coefficient amplitude and coefficient phase.

The details about the reporting of the coefficients comprising \tilde{W}₂ is according to at least one of the following embodiments.

In one embodiment I.1, the UE is configured to report all coefficients that comprise \tilde{W}₂. For rank 1 (v=1), all Z=2LM₁ or K₁M₁ coefficients are reported. For rank v>1, all Z^{tot}=v2LMᵥ or vK₁Mᵥ coefficients are reported. Alternatively, when the strongest coefficient (e.g., for each layer, 1 out of the all coefficients comprising \tilde{W}₂) is reported separately by the UE, then Z^{tot}−v=v2LMᵥ−v or vK₁Mᵥ−v coefficients are reported, where “−v” corresponds to the fact the amplitude/phase of the strongest coefficient doesn't need to be reported since the strongest coefficient can be fixed to 1. The details about the strongest coefficient are described later in this disclosure.

In one embodiment I.2, the UE is configured to report a subset of all the coefficients comprising \tilde{W}₂. For example, the UE can be configured to report up to a maximum number (K₀) of non-zero (NZ) coefficients. Hence, a subset of the total Z^{tot} coefficients can be non-zero, and the remaining can be zero. Let Kₗ^{NZ} denote the number of nonzero (NZ) coefficients for layer l=1, . . . , v and K^{NZ}=Σₗ₌₁^{v}Kₗ^{NZ} denote the total number of nonzero coefficients across all layers, where the UE reports the rank indicator (RI) value v, which for example, can be according to (based on) the configured higher layer parameter typeII-RI-Restriction-r17 that configures the set of allowed rank or RI values. In one example, Kₗ^{NZ} has an upper bound such as Kₗ^{NZ}≤K₀, where K₀ can be fixed or can be configured via higher layer (explicitly or via a parameter). For example, K₀=┌βZ┐ or ┌βZᵥ┐, where β≤1 determines the number of NZ coefficients. For v>1, the total K^{NZ} can also be upper bounded, e.g., K^{NZ}≤2K₀.

Alternatively, when the strongest coefficient (e.g., for each layer, 1 out of all coefficients comprising \tilde{W}₂) is reported separately by the UE, then K^{NZ}−v coefficients are reported, where “−v” corresponds to the fact the amplitude/phase of the strongest coefficient doesn't need to be reported since the strongest coefficient can be fixed to 1. The details about the strongest coefficient are described later in this disclosure.

In one example I.2.1, the UE reports an indicator to indicate the location (indices) of the NZ coefficients. Since the locations of NZ coefficients are reported, the UE only needs to report the quantized value (e.g., amplitude/phase) of the NZ coefficients (the remaining coefficients can be set to 0 value). At least one of the following examples is used/configured.
In one example I.2.1.1, the indicator indicates a bitmap (or bit sequence), similar to R16 Type II codebook. The total length of bitmap for all layers is Z^{tot}=v2LMᵥ or vK₁Mᵥ, and the per layer bitmap has a length Z=2LMᵥ or K₁Mᵥ. In one example, when a bit bᵢ in the bitmap takes a value bᵢ=1, the corresponding coefficient is NZ; otherwise (when a bit bᵢ in the bitmap takes a value bᵢ=0), the corresponding coefficient is 0. Or, when a bit bᵢ in the bitmap takes a value bᵢ=0, the corresponding coefficient is NZ; otherwise (when a bit bᵢ in the bitmap takes a value bᵢ=1), the corresponding coefficient is 0. The details of the indicator can be the same (bitmap) in Rel. 16 Type II codebook. The indicator can be joint (one indicator) across all layers. Or, the indicator can be separate (one) for each layer.
In one example I.2.1.2, the indicator indicates a combinatorial index. When the indicator is separate (one) for each layer, it takes a value from {0, 1, . . . , (_{K}_{ₗ}_{^{NZ}}^{Z}^{ᵥ})−1} for layer l. Hence, the payload (number of bits) of this indicator is ┌log₂(_{K}_{ₗ}_{^{NZ}}^{Z}^{ᵥ})┐. Or, the indicator can be joint (one indicator) across all layers, and, it takes a value from {0, 1, . . . , (_{K}_{^{NZ}}^{Z}^{^{tot}})−1}. Hence, the payload (number of bits) of this indicator is ┌log₂(_{K}_{^{NZ}}^{Z}^{^{tot}})┐.
In one example I.2.1.3, the indicator indicates a bitmap or a combinatorial index according to at least one of the following examples.
   In one example I.2.1.3.1, the UE configured with the information that whether the indicator indicates a bitmap or a combinatorial index.
   In one example I.2.1.3.2, the indicator indicates a bitmap or a combinatorial index based on a condition.
      In one example, the condition is based on the number of CSI-RS ports configured for the CSI reporting. For example, a bitmap is used when P_{CSIRS} is small, P_{CSIRS}≤t and a combinatorial index is used when P_{CSIRS} is large, P_{CSIRS}≥t, where t is a threshold (fixed or configured). Or, a combinatorial index is used when P_{CSIRS} is small, P_{CSIRS}≤t and a bitmap is used when P_{CSIRS} is large, P_{CSIRS}>t, where t is a threshold (fixed or configured).
      In one example, the condition is based on the value of Zᵥ. For example, bitmap is used when Zᵥ is small, Zᵥ≤t and a combinatorial index is used when Zᵥ is large, Zᵥ>t, where t is a threshold (fixed or configured). Or, a combinatorial index is used when Zᵥ is small, Zᵥ≤t and a bitmap is used when Zᵥ is large, Zᵥ>t, where t is a threshold (fixed or configured).
      In one example, the condition is based on the rank value v. For example, bitmap is used when v is small, v≤t and a combinatorial index is used when v is large, v>t, where t is a threshold (fixed or configured). Or, a combinatorial index is used when v is small, v≤t and a bitmap is used when v is large, v>t, where t is a threshold (fixed or configured).
      In one example, the condition is based on the value of L (or K₁) or/and Mᵥ. For example, bitmap is used when L (or K₁) or/and Mᵥ is small, and a combinatorial index is used when L (or K₁) or/and Mᵥ is large. Or, a combinatorial index is used when L (or K₁) or/and Mᵥ is small, and a bitmap is used when L (or K₁) or/and Mᵥ is large.

In one example I.2.2, when v>1, at least one of the following examples is used/configured regarding the (locations) indices of the NZ coefficients.
In one example I.2.2.1, the NZ coefficients are common across all layers, i.e., the locations (indices) of the NZ coefficients remain the same (is common) for all l=1, . . . , v values, hence they are reported via one common reporting. If the CSI-RS antenna ports correspond are dual-polarized, there are two polarizations or groups, a first polarization or group of antenna ports, which for example includes antenna ports 0, 1, . . . ,

$$\frac{{P}_{CSIRS}}{2} - 1 ;$$

and a second polarization or group of antenna ports, which for example includes antenna

$$ports \frac{{P}_{CSIRS}}{2} , \frac{{P}_{CSIRS}}{2} + 1 , … , {P}_{CSIRS} - 1 .$$

In one example, I.2.2.1.1, the NZ coefficients are common across two antenna polarizations or groups of antenna ports, i.e., the locations (indices) of the NZ coefficients remain the same (is common) for all l=1, . . . , v values and for all p=0, 1 (polarization index). When a bitmap is used to report the locations of NZ coefficients, then the bitmap has LMᵥ or

$$\frac{{K}_{1} {M}_{υ}}{2} bits .$$

In one example, I.2.2.1.2, the NZ coefficients are independent for two antenna polarizations or groups of antenna ports, i.e., the locations (indices) of the NZ coefficients remain the same (is common) for all l=1, . . . , v values but they are independent for p=0, 1 (polarization index). When a bitmap is used to report the locations of NZ coefficients, then the bitmap has 2LMᵥ or K₁Mᵥ bits.
In one example I.2.2.2, the NZ coefficients are independent for each layer, i.e., the locations (indices) of the NZ coefficients can be different across l=1, . . . , v values, hence, they are reported separately for each layer. If the CSI-RS antenna ports correspond are dual-polarized, there are two polarizations or groups, a first polarization or group of antenna ports, which for example includes antenna ports 0, 1, . . . ,

$$\frac{{P}_{CSIRS}}{2} - 1 ;$$

and a second polarization or group of antenna ports, which for example includes antenna ports

$$\frac{{P}_{CSIRS}}{2} , \frac{{P}_{CSIRS}}{2} + 1 , … , {P}_{CSIRS} - 1 .$$

In one example, I.2.2.2.1, the NZ coefficients are common across two antenna polarizations or groups of antenna ports, i.e., the locations (indices) of the NZ coefficients are independent for each l=1, . . . , v values but they are common for all p=0, 1 (polarization index). When a bitmap is used to report the locations of NZ coefficients, then the bitmap has vLMᵥ or

$$\frac{{υK}_{1} {M}_{υ}}{2}$$

bits in total, and LMᵥ or

$$\frac{{K}_{1} {M}_{υ}}{2}$$

bits for each layer.
In one example, I.2.2.2.2, the NZ coefficients are independent for two antenna polarizations or groups of antenna ports, i.e., the locations (indices) of the NZ coefficients are independent for each l=1, . . . , v values and also for each p=0, 1 (polarization index). When a bitmap is used to report the locations of NZ coefficients, then the bitmap has v2LMᵥ or vK₁Mᵥ bits in total, and 2LMᵥ or K₁Mᵥ bits for each layer.
In one example I.2.2.3, the NZ coefficients are common within a subset of layers, and are independent across two subsets of layers. For example, the NZ coefficients are common for a subset of layers {1,2}, and are common for a subset of layers {3,4}, but they are independent across the two subsets of layers.

In one example I.2.3, when v≥1, the number of NZ coefficients across different layers can be restricted according to at least one of the following examples.
In one example I.2.3.1, For v=1, K₁^{NZ} has an upper bound such as K₁^{NZ}≤K₀, where K₀ can be fixed or can be configured via higher layer (explicitly or via a parameter). For v>1, the total K^{NZ} is upper bounded, e.g., K^{NZ}≤2K₀.
In one example I.2.3.2, for each l=1, . . . , v, Kᵢ^{NZ} has an upper bound such as Kₗ^{NZ}≤K₀, where K₀ can be fixed or can be configured via higher layer (explicitly or via a parameter). For example, K₀=┌βZ┐ or ┌βZᵥ┐, where β≤1 determines the number of NZ coefficients. For v>1, the total K^{NZ} is upper bounded, e.g., K^{NZ}≤2K₀.

In one embodiment I.3, the UE is configured to report either all coefficients (cf. embodiment I.1) or a subset of coefficients (cf. embodiment I.2) according to at least one of the following examples.
In one example I.3.1, the UE is configured with whether the UE needs to report all coefficients or a subset of coefficients. This configuration can be explicit, e.g., via higher layer (RRC) signaling or/and MAC CE based signaling or/and DCI based signaling. Or, this configuration can be implicit, e.g., via a codebook parameter. For example, for a certain value of one or more than one codebook parameters, all coefficients need to be reported, where the one or more than one codebook parameters comprise β, L (or K₁), Mᵥ, or rank value.
In one example I.3.2, the UE is configured with whether the UE needs to report all coefficients or a subset of coefficients based on a condition on the value of Mᵥ. For example, all coefficients are reported when Mᵥ is small, Mᵥ≤t and a subset of coefficients are reported when Mᵥ is large, Mᵥ>t, where t is a threshold (fixed or configured). Or, all coefficients are reported when Mᵥ is small, Mᵥ≤t and a subset of coefficients are reported when Mᵥ is large, Mᵥ>t, where t is a threshold (fixed or configured). In one example, t=1, which implies that the condition Mᵥ≤t is equivalent to Mᵥ=1.
In one example I.3.3, the UE is configured with whether the UE needs to report all coefficients or a subset of coefficients based on the rank value v. For example, all coefficients are reported when v is small, v≤t and a subset of coefficients are reported when v is large, v>t, where t is a threshold (fixed or configured). Or, all coefficients are reported when v is small, v≤t and a subset of coefficients are reported when v is large, v>t, where t is a threshold (fixed or configured).
In one example I.3.4, the UE is configured with whether the UE needs to report all coefficients or a subset of coefficients based on the number of CSI-RS ports P_{CSIRS} configured for the CSI reporting. For example, all coefficients are reported when P_{CSIRS} is small, P_{CSIRS}≤t and a subset of coefficients are reported when P_{CSIRS} is large, P_{CSIRS}>t, where t is a threshold (fixed or configured). Or, all coefficients are reported when P_{CSIRS} is small, P_{CSIRS}≤t and a subset of coefficients are reported when P_{CSIRS} is large, P_{CSIRS}>t, where t is a threshold (fixed or configured).
In one example I.3.5, the UE is configured with whether the UE needs to report all coefficients or a subset of coefficients based on the value of Zᵥ. For example, all coefficients are reported when Zᵥ is small, Zᵥ≤t and a subset of coefficients are reported when Zᵥ is large, Zᵥ>t, where t is a threshold (fixed or configured). Or, all coefficients are reported when Zᵥ is small, Zᵥ≤t and a subset of coefficients are reported when Zᵥ is large, Zᵥ>t, where t is a threshold (fixed or configured).
In one example I.3.6, the UE is configured with whether the UE needs to report all coefficients or a subset of coefficients based on a condition on the value of L (or K₁). For example, all coefficients are reported when L is small, L≤t and a subset of coefficients are reported when L is large, L>t, where t is a threshold (fixed or configured). Or, all coefficients are reported when L is small, L≤t and a subset of coefficients are reported when L is large, L>t, where t is a threshold (fixed or configured).
In one example I.3.7, the UE is configured with whether the UE needs to report all coefficients or a subset of coefficients based on a condition on the value of L (or K₁) and the value of Mᵥ.

In one embodiment II.1, the UE is configured to report the strongest coefficient (e.g., for each layer, 1 out of all coefficients comprising \tilde{W}₂).

In one example II.1.1, when v≥1, the strongest coefficient is reported according to at least one of the following examples.
In one example II.1.1.1, the strongest coefficient is reported common for all layers l=1, . . . , v, i.e., the location (index) of the strongest coefficient remains the same (is common) for all l=1, . . . , v values. The strongest coefficient can be identified by strongest coefficient index (SCI) index i_{1,8}, where i_{1,8} either indicates the SD index iₗ* or (SD, FD) index pair (iₗ*, fₗ*). Or, the strongest coefficient can be identified by SCI index pair (i_{1,8}, i_{1,9}), where i_{1,8} and i_{1,9} indicate the SD and FD indices iₗ* and fₗ*, respectively.
In one example II.1.1.2, the strongest coefficient is reported independently for each layer, i.e., the location (index) of the strongest coefficient can be different across layers, hence, it is reported for each layer l=1, . . . , v separately (independently). The strongest coefficient of layer l can be identified by SCI index i_{1,8,l} where i_{1,8,l} either indicates the SD index it or (SD, FD) index pair (iₗ*, fₗ*). Or, the strongest coefficient can be identified by index pair (i_{1,8,l},i_{1,9,l}), where i_{1,8,l} and i_{1,9,l} indicate the SD and FD indices iₗ* and fₗ*, respectively.
   When strongest coefficient is reported common for all layers, then iₗ*=iₗ* and fₗ*=f* for all layers.

In one example II.1.2, the strongest coefficient indicator (SCI) identified by index i_{1,8} or i_{1,8,l} indicates at least one of the following.
In one example II.1.2.1, the SCI for layer l indicates an index pair (iₗ*, fₗ*), which indicates (row, column) indices of a (strongest) coefficient out of Zᵥ=2LMᵥ or K₁Mᵥ that comprise the coefficient matrix \tilde{W}₂. In this example, i_{1,8,l}∈{0, 1, . . . , Kₗ^{NZ}−1} or {0, 1, . . . , Zᵥ−1} or {0, 1, . . . , K₀−1}, where K₀=┌βZ┐ or ┌βZᵥ┐, where β≤1 determines the number of NZ coefficients and is fixed or configured. When i_{1,8,l}∈{0, 1, . . . , Zᵥ−1}, the strongest coefficient indicator (SCI) of the lth layer is represented with ┌log₂(K₁Mᵥ)┐ or ┌log₂(K₁)┐+┌log₂(Mᵥ)┐ bits. This can implicitly imply whether the FD component of the strongest coefficient has been re-mapped (as below) to a fixed position. For example, the remapping corresponds to shifting the FD index of the strongest coefficient to a position FD index fₗ*=0. The details of the shifting (re-mapping) are according to an example in example II.1.2.2.
In one example II.1.2.2, the SCI for layer l indicates an index i* which indicates (row) index of a (strongest) coefficient out of 2L or K₁. The column index fₗ* of the (strongest) coefficient can be fixed, e.g., fₗ*=0, or configured, or can be reported via another indicator, e.g., i_{1,9} (if layer-common) or i_{1,9,l} (if reported for each layer l), that indicates a modulo shift (re-mapping) operation or just a shift (re-mapping) operation. For FD basis vectors, the modulo-shift operation can be (n_{3,l}^{(f)}−n_{3,l}^{(f}^{ₗ}^{*)}) mod N₃, or (n_{4,l}^{(f)}−n_{4,l}^{(f}^{ₗ}^{*)}) mod N, or the shift (re-mapping) operation can be (n_{3,l}^{(f)}−n_{3,l}^{(f}^{ₗ}^{*)}) or (n_{4,l}^{(f)}−n_{4,l}^{(f}^{ₗ}^{*)}), where n_{3,l}^{(f)} is an FD basis index within the set of orthogonal DFT basis vectors and takes a value from {0, 1, . . . , N₃−1}, n_{4,l}^{(f)} is an FD basis index within a size N window of basis vectors, and takes a value from {0, 1, . . . , N−1}, and n_{3,l}^{(f}^{ₗ}^{*)} and n_{4,l}^{(f}^{ₗ}^{*)} are FD indices with respect to which the modulo-shift or shift (re-mapping) operations are applied to n_{3,l}^{(f)} and n_{4,l}^{(f)}, respectively. For column indices of the coefficients c_{l,i,f}, the modulo-shift operation can be f=(f−fₗ*) mod Mᵥ, where fₗ* is an FD index with respect to which the modulo-operation is applied to f. In this example, i_{1,8,l}∈{0, 1, . . . , 2L−1} or {0, 1, . . . , K₁−1} indicates the SCI via ┌log₂ Xₗ┐ bits, where Xₗ=2L or K₁.
In one example II.1.2.2A, the SCI for layer l is according to example II.1.2.1 or 11.1.2.2, and there is a (modulo-) shift operation performed on the FD basis vectors. For example, the modulo-shift operation can be (n_{3,l}^{(f)}−n_{3,l}^{(f}^{_{ref}}⁾) mod N₃, or (n_{4,l}^{(f)}−n_{4,l}^{(f}^{_{ref}}⁾) mod N, or the shift (re-mapping) operation can be (n_{3,l}^{(f)}−n_{3,l}^{(f}^{_{ref}}⁾) or (n_{4,l}^{(f)}−n_{4,l}^{(f}^{_{ref}}⁾), where f_{ref} is a reference FD index which is fixed (e.g., f_{ref}=0 or f_{ref}=fₗ*) or configured or reported by the UE. For column indices of the coefficients c_{l,i,f}, the modulo-shift operation can be as explained in example II.1.2.2.
In one example II.1.2.3, the SCI for layer l indicates an index pair (iₗ*, fₗ*) (cf. example 11.1.2.1) or just an index i* (cf. example II.1.2.2) based on explicit signaling (e.g., via higher layer) or implicitly (e.g., based on codebook parameters) or based on a condition.
In one example II.1.2.4, same as example II.1.2.2 except that the modulo-shift operation is not applied when Mᵥ=1 or/and N=1 is configured, and the modulo-shift operation is applied only when Mᵥ>1 (e.g., Mᵥ=2) is configured. When the modulo-shift operation is not applied, the another indicator, e.g., i_{1,9} or i_{1,9,l} or fₗ* is not reported, and when the modulo-shift operation is applied, the another indicator, e.g., i_{1,9} or i_{1,9,l} or fₗ*is reported.

In the above examples, Mᵥ (FD basis) vectors, [y_{0,l}^{(f)},y_{1,l}^{(f)}, . . . ,y_{N}_{₃}_{-1,l}^{(f)}]^{T}, f=0, 1, . . . , Mᵥ−1, are identified by n_{3,1}(l=1, . . . , v) where

$${n}_{3 , l} = [ {n}_{3 , 1}^{( 0 )} , … , {n}_{3 , 1}^{( {M}_{υ} - 1 )} ]$$

$${n}_{3 , 1}^{( f )} ∈ \{ 0 , 1 , … , N - 1 \}$$

which are indicated by means of the PMI index, e.g., i_{1,6,l}, where

$${y}_{t , l}^{( f )} = {e}^{j \frac{2 π {tn}_{3 , l}^{( f )}}{{N}_{3}}} .$$

In the above examples, when the (modulo-) shift operation is applied, the indices of n_{3,l} are remapped with respect to n_{3,l}^{(x)} as n_{3,l}^{(f)}=(n_{3,l}^{(f)}−n_{3,l}^{(x)}) mod N₃, such that n_{3,l}^{(x)}=0, after remapping. The index f is remapped with respect to x as f=(f−x) mod Mᵥ, such that the index of the strongest coefficient is x=0 (l=1, . . . , v), after remapping. Here, x=fₗ* or f_{ref}, as in the above examples.

In one example, the FD basis vectors and the Mᵥ are layer common (i.e, the same for all layers). In the case, the subscripts ‘l’ from n_{3,l}^{(f)} and ‘v’ from Mᵥ can be dropped. That is, M (FD basis) vectors, [y₀^{(f)},y₁^{(f)}, . . . ,y_{N}_{₃}₋₁^{(f)}]^{T}, f=0, 1, . . . , M−1, are identified by n₃,where

n₃=[n₃⁽⁰⁾ . . . n₃^{(M-1)}]

n₃^{(f)}∈{0,1, . . . ,N−1} when M=2, and n₃^{(f}=0 when M=1

which are indicated by means of the PMI index, e.g., i_{1,6}, when M=2 and N=4 where

$${y}_{t}^{( f )} = {e}^{j \frac{2 π {tn}_{3}^{( f )}}{{N}_{3}}} .$$

The PMI indices for amplitude, phase and bitmap (e.g., i_{2,4,l}, i_{2,5,l} and i_{1,7,l}) indicate amplitude coefficients, phase coefficients and bitmap after remapping. Or, The PMI indices for amplitude and phase (e.g., i_{2,4,l}, i_{2,5,l}) indicate amplitude coefficients and phase coefficients after remapping; the PMI indices for bitmap (e.g., i_{1,7,l}) indicate the bitmap without remapping.

In case of the SCI (i_{1,8,l}) reported from {0, 1, . . . , K₀−1}, the SCI is calculated from the bitmap B=[b_{i,f}], b_{i,f}∈{0,1} and [iₗ*,fₗ*] for example as follows: SCI=Σ_{f=0}^{f}^{ₗ}^{^{*}}₋₁Σᵢ₌₀^{K}^{₁}b_{i,f}+Σᵢ₌₀ⁱ^{ₗ}^{^{*}}b_{i,f}_{ₗ}_{^{*}}−1.

In case of the SCI (i_{1,8,l}) is reported as [iₗ*,fₗ*] with ┌log₂(K₁Mᵥ)┐ or ┌log₂(K₁)┐+┌log₂(Mᵥ)┐ bits, the SCI is calculated as follows: SCI=K₁fₗ*+iₗ*, and [iₗ*,fₗ*] is determined from SCI as iₗ*=SCI mod K₁ and

$${f}_{l}^{*} = \frac{SCI - {i}_{l}^{*}}{{K}_{1}} .$$

Or the SCI is calculated as follows: SCI=Mᵥiₗ*+fₗ*, and [iₗ*,fₗ*] is determined from SCI as fₗ*=SCI mod M_{U} and

$${i}_{l}^{*} = \frac{SCI - {f}_{l}^{*}}{{M}_{υ}} .$$

In case of the SCI is reported as [iₗ*] with ┌log₂(K₁)┐ bits, the SCI is calculated as follows: SCI=iₗ*.

In one example II.1.3, for layer l, the payload (number of bits) of the strongest coefficient indicator (SCI) reporting is ┌log₂ Xₗ┐ bits, where Xₗ is according to at least one of the following examples.
In one example II.1.3.1, Xₗ=2L or K₁
In one example II.1.3.1A, Xₗ=2L or K₁, as in example II.1.2.2 or II.1.2.2A; a modulo-shifting operation is applied to the FD indices, as described in example II.1.2.2 or II.1.2.2A, which can be reported via an indicator, e.g., i_{1,9} (if layer-common) or i_{1,9,l} (if reported for each layer l), using ┌log₂ N┐ bits, where N is the size of window-basis fixed or configured to the UE, where the start of the window can be Mᵢₙᵢₜ=0, and the window comprises consecutive FD basis vectors from an orthogonal DFT matrix. Or, the indicator, e.g., i_{1,9} (if layer-common) or i_{1,9,l} (if reported for each layer l), is reported using ┌log₂ Mᵥ┐ bits. When N=1 or M=1, the another indicator, e.g., i_{1,9} or i_{1,9,l}=0, hence not reported, and when N=2 or Mᵥ=2, i_{1,9} or i_{1,9,l} is reported using 1-bit, and when N=3 or 4, or Mᵥ=3 or 4, i_{1,9} or i_{1,9,l} is reported using 2-bits.
In one example II.1.3.2, Xₗ=Kₗ^{NZ} or K₀
In one example II.1.3.2A, Xₗ=Kₗ^{NZ} or K₀, as in example II.1.2.1; a modulo-shifting operation is applied to the FD indices, as described in example II.1.2.2 or II.1.2.2A, which can be reported via an indicator, e.g., i_{1,9} (if layer-common) or i_{1,9,l} (if reported for each layer l), using ┌log₂ N┐ bits, where N is the size of window-basis fixed or configured to the UE, where the start of the window can be Mᵢₙᵢₜ=0, and the window comprises consecutive FD basis vectors from an orthogonal DFT matrix. Or, the indicator, e.g., i_{1,9} (if layer-common) or i_{1,9,l} (if reported for each layer l), is reported using ┌log₂ Mᵥ┐ bits. When N=1 or Mᵥ=1, the another indicator, e.g., i_{1,9} or i_{1,9,l}=0, hence not reported, and when N=2 or Mᵥ=2, i_{1,9} or i_{1,9,l} is reported using 1-bit, and when N=3 or 4, or Mᵥ=3 or 4, i_{1,9} or i_{1,9,l} is reported using 2-bits.
In one example II.1.3.3, Xₗ=min(Kₗ^{NZ}, 2L) or min(K₀,2L)
In one example II.1.3.3A, Xₗ=min(Kₗ^{NZ}, 2L) or min(K₀,2L), as in example II.1.2.1 and II.1.2.2 or II.1.2.2A; a modulo-shifting operation is applied to the FD indices, as described in example II.1.2.2 or II.1.2.2A, which can be reported via an indicator, e.g., i_{1,9} (if layer-common) or i_{1,9,l} (if reported for each layer l), using ┌log₂ N┐ bits, where N is the size of window-basis fixed or configured to the UE, where the start of the window can be Mᵢₙᵢₜ=0, and the window comprises consecutive FD basis vectors from an orthogonal DFT matrix. Or, the indicator, e.g., i_{1,9} (if layer-common) or i_{1,9,l} (if reported for each layer l), is reported using ┌log₂ Mᵥ┐ bits. When N=1 or Mᵥ=1, the another indicator, e.g., i_{1,9} or i_{1,9,l}=0, hence not reported, and when N=2 or Mᵥ=2, i_{1,9} or i_{1,9,l} is reported using 1-bit, and when N=3 or 4, or Mᵥ=3 or 4, i_{1,9} or i_{1,9,l} is reported using 2-bits.
In one example II.1.3.4, Xₗ=Zᵥ=2LMᵥ or K₁Mᵥ
In one example II.1.3.4A, Xₗ=Zᵥ=2LMᵥ or K₁Mᵥ, as in example II.1.2.1; a modulo-shifting operation is applied to the FD indices, as described in example II.1.2.2 or II.1.2.2A, which can be reported via an indicator, e.g., i_{1,9} (if layer-common) or i_{1,9,l} (if reported for each layer l), using ┌log₂ N┐ bits, where N is the size of window-basis fixed or configured to the UE, where the start of the window can be Mᵢₙᵢₜ=0, and the window comprises consecutive FD basis vectors from an orthogonal DFT matrix. Or, the indicator, e.g., i_{1,9} (if layer-common) or i_{1,9,l} (if reported for each layer l), is reported using ┌log₂ Mᵥ┐ bits. When N=1 or Mᵥ=1, the another indicator, e.g., i_{1,9} or i_{1,9,l}=0, hence not reported, and when N=2 or Mᵥ=2, i_{1,9} or i_{1,9,l} is reported using 1-bit, and when N=3 or 4, or Mᵥ=3 or 4, i_{1,9} or i_{1,9,l} is reported using 2-bits.
In one example II.1.3.5, Xₗ=min(Kₗ^{NZ},Zᵥ)
In one example II.1.3.6, Xₗ=min(2L,Zᵥ)
In one example II.1.3.7, Xₗ=min(Kₗ^{NZ},Zᵥ,2L)

In one example II.1.4, for layer l, the payload (number of bits) of the strongest coefficient indicator (SCI) reporting is ┌log₂ Xₗ┐+┌log₂ Yₗ┐ bits, where Xₗ and Yₗ are according to at least one of the following examples
In one example II.1.4.1, Xₗ=K₁ or 2L and Yₗ=Mᵥ
In one example II.1.4.2, Xₗ=K₁ or 2L and Yₗ=Mᵥ, as in example II.1.2.1; a modulo-shifting operation is applied to the FD indices, as described in example II.1.2.2 or II.1.2.2A, which can be reported via an indicator, e.g., i_{1,9} (if layer-common) or i_{1,9,l} (if reported for each layer l), using ┌log₂ N┐ bits, where N is the size of window-basis fixed or configured to the UE, where the start of the window can be Mᵢₙᵢₜ=0, and the window comprises consecutive FD basis vectors from an orthogonal DFT matrix. Or, the indicator, e.g., i_{1,9} (if layer-common) or i_{1,9,l} (if reported for each layer l), is reported using ┌log₂ Mᵥ┐ bits. When N=1 or Mᵥ=1, the another indicator, e.g., i_{1,9} or i_{1,9,l}=0, hence not reported, and when N=2 or Mᵥ=2, i_{1,9} or i_{1,9,l} is reported using 1-bit, and when N=3 or 4, or Mᵥ=3 or 4, i_{1,9} or i_{1,9,l} is reported using 2-bits.

In one example II.1.5, when the strongest coefficient is identified by index pair (i_{1,8,l},i_{1,9,l}), the two indices can be reported via a two part uplink control information (UCI), namely UCI part 1 and UCI part 2 according to at least one of the following examples:
In one example II.1.5.1, the two indicators (i_{1,8,l},i_{1,9,l}) are reported together in UCI part 1.
In one example II.1.5.2, the two indicators (i_{1,8,l},i_{1,9,l}) are reported together in UCI part 2.
In one example II.1.5.3, the two indicators (i_{1,8,l},i_{1,9,l}) are reported together in UCI part 2. When UCI part 2 comprises three groups G0, G1, and G2 (cf. Rel. 16 UCI for enhanced Type II codebook),
   In one example, the two indicators (i_{1,8,l},i_{1,9,l}) are reported together in G0.
   In one example, the two indicators (i_{1,8,l},i_{1,9,l}) are reported together in G1.
   In one example, the two indicators (i_{1,8,l},i_{1,9,l}) are reported together in G2.
In one example II.1.5.4, the two indicators (i_{1,8,l},i_{1,9,l}) are reported separate, for example, i_{1,8,l} in UCI part 1 and i_{1,9,l} in UCI part 2, or vice versa.
In one example II.1.5.5, the two indicators (i_{1,8,l},i_{1,9,l}) are reported separate, for example, i_{1,8,l} in UCI part 1 and i_{1,9,l} in group G0 of the UCI part 2, or vice versa.
In one example II.1.5.6, the two indicators (i_{1,8,l},i_{1,9,l}) are reported separate, for example, i_{1,8,l} in group Gᵢ of the UCI part 2 and i_{1,9,l} in group Gⱼ of the UCI part 2. In one example, (i,j)=(0,1) or (1,2) or (1,0) or (2,1).

In one embodiment II.1A, at least one of the following examples is used/configured regarding the shift operation and/or the window-based based FD basis vectors as described in this disclosure (e.g., embodiment II.1).
In one example II.1A.1, there is only one window based FD basis vectors (fixed or configured), and there are no shift operations applied.
In one example II.1A.2, there is only one window based FD basis vectors (fixed or configured), and there are shift operations applied by the UE, and the UE reports any necessary information about this.
In one example II.1A.3, there is only one window based FD basis vectors (fixed or configured), and the UE can apply the shift operations (on FD basis vectors or/and on column indices of coefficients), and if the UE does apply operations, the UE reports this, e.g., as part of the CSI report. For example, when the FD index of the strongest coefficient is 0, the UE doesn't apply any shift operations, and otherwise, the UE applies the shift operations.
In one example II.1A.4, there is only one window based FD basis vectors (fixed or configured), and whether shift operations are applied or not is configured to the UE (e.g., via higher layer RRC or/and MAC CE or/and DCI based signaling). The UE follows the configuration. For example, when Mᵥ=1, the UE doesn't apply any shift operations, and otherwise (Mᵥ>2), the UE applies the shift operations. For example, this configuration can be via an explicit configuration (e.g., via higher layer RRC or/and MAC CE or/and DCI based signaling).
In one example II.1A.5, the UE reports in its capability reporting an information about whether the UE supports the shift operations. Any configuration about shift operations is subject to UE capability reported by the UE.
In one example II.1A.6, there are multiple sets of window based FD basis vectors (fixed or configured), for example to facilitate shift operations. For example, the multiple sets of window basis FD basis vectors correspond to different shift operations. There are shift operations applied by the UE, and the UE reports any necessary information about this.
In one example II.1A.7, there is only one or multiple window based FD basis vectors (fixed or configured). In case of only one window, there are no shift operations applied; and in case of multiple windows, there are shift operations applied.
In one example II.1A.8, one or multiple windows is based on a configuration (e.g., via higher layer RRC or/and MAC CE or/and DCI based signaling).
In one example II.1A.9, one or multiple windows is based on a UE capability reporting. Any configuration about shift operations is subject to UE capability reported by the UE.

In one embodiment II.1B, the FD bases used for W_{f} quantization and reporting are limited within Z window(s) that is (are) configured to the UE, where the FD bases in the window are consecutive from an orthogonal DFT matrix.
In one example II.1B.1, Z=1, i.e., there is only one window of size 2N−1; and the W_{f} quantization and reporting is restricted (limited) within a sub-window (smaller window) within configured window, the size of the sub-window is N and the starting (initial) index of the sub-window is Mᵢₙᵢₜ∈{−(N−1), 1, . . . 0}, which is reported by the UE.
In one example II.1B.2, Z=N, i.e., there are N windows each of size N and Mᵢₙᵢₜ for the N windows are −(N−1), 1, . . . , 0. The UE reports one of the N windows using ┌log₂ N┐ bits, or reports Mᵢₙᵢₜ∈{−(N−1), 1, . . . 0} indicating the start of the size N window. The W_{f} quantization and reporting is restricted (limited) within the reported window.
In one example II.1B.3, Z=1, i.e., there is only one window of size N and the start of the window is fixed to Mᵢₙᵢₜ=0. The W_{f} quantization and reporting is allowed to be within the configured window or outside the configured window but (with) up to a modulo shift operation such that after the modulo-shift operation, the W_{f} is within the configured window.
In one example II.1B.4, the FD bases used for W_{f} quantization and reporting is according to one example II.1B.1 through II.1B.3 or other examples explained in this disclosure subject to a condition. For example, the condition corresponds to the case when N>Mᵥ.

In one embodiment II.1C, as explained in example II.1.2.2A, there can be a (modulo-) shift operation performed on the FD basis vectors by the UE for the reporting of FD basis indices.
In one example, the modulo-shift operation can be (n_{3,l}^{(f)}−n_{3,l}^{(f}^{_{ref}}⁾) mod N₃, or (n_{4,l}^{(f)}−n_{4,l}^{(f}^{_{ref}}⁾) mod N,
In one example, the shift (re-mapping) operation can be (n_{3,l}^{(f)}−n_{3,l}^{(f}^{_{ref}}⁾) or (n_{4,l}^{(f)}−n_{4,l}^{(f}^{_{ref}}⁾), where f_{ref} is a reference FD index which is fixed (e.g., f_{ref}=0 or f_{ref}=fₗ*) or configured or reported by the UE.

When Mᵥ=2, the values of f=0, 1, and the two FD basis indices (indicating columns of W_{f}) are {n_{3,l}⁽⁰⁾,n_{3,l}⁽¹⁾} or {n_{4,l}⁽⁰⁾,n_{4,l}⁽¹⁾} when they are layer-specific, and are {n₃⁽⁰⁾,n₃⁽¹⁾} or {n₄⁽⁰⁾,n₄⁽¹⁾} when they are layer-common.

When Mᵥ=2, the window size N is configured via RRC. (e.g., N=2,4). When N>Mᵥ, the Mᵥ=2 FD basis vectors are selected by the UE.
In one example, the two FD basis indices are selected from the full set of basis indices {0, 1, . . . , N₃−1}.
In one example, the two FD basis indices are selected from the window of basis indices {0, 1, . . . , N−1}.

For Mᵥ=2 or M=2 (when Mᵥ is layer-common, the same value for all layers), as explained above, there are two FD basis indices (as explained), namely a lower and higher FD indices, i.e., n₃⁽⁰⁾ and n₃⁽¹⁾ or n₄⁽⁰⁾ and n₄⁽¹⁾.

If M=1, or M=2 and N=2, the PMI index for the FD basis vectors i_{1,6} is not reported, and n₃⁽⁰⁾=0 and n₃⁽¹⁾=1.

For reporting (e.g., via PMI component), when M=2 and N=4, at least one of the following examples is used.

In one example (II.1C.1), the non-zero offset Oₗ^{(f)} between the lower and higher FD indices, n₃⁽⁰⁾ and n₃⁽¹⁾ (or n₄⁽⁰⁾ and n₄⁽¹⁾, is reported with i_{1,6}∈{0, 1,2} by using ┌log₂(N−1)┐ bits (which is 2 bits when N=4), assuming that the lower FD index n₃⁽⁰⁾ (or n₄⁽⁰⁾) (reference for the offset) is 0. The nonzero offset is found from i_{1,6}+1.

In one example, when N₃=3, then M=2 and N=4 can't be configured (i.e., the UE is not expected to be configured with M=2 and N=4 when N₃=3.

In one example, when N₃=3, then M=2 and N=N₃=3 is configured. In that case, the non-zero offset Oₗ^{(f)} between the lower and higher FD indices, n₃⁽⁰⁾ and n₃⁽¹⁾ (or n₄⁽⁰⁾ and n₄⁽¹⁾), is reported with i_{1,6}∈{0,1} by using ┌log₂(N−1)┐ bits (which is 1 bit when N=N₃=3), assuming that the lower FD index n₃⁽⁰⁾ (or n₄⁽⁰⁾) (reference for the offset) is 0. The nonzero offset is found from i_{1,6}+1.

In one example, the value N=4 is replaced with N=min(N₃, 4), and then the non-zero offset Oᵢ^{(f)} between the lower and higher FD indices, n₃⁽⁰⁾ and n₃⁽¹⁾ (or n₄⁽⁰⁾ and n₄⁽¹⁾), is reported with i_{1,6}∈{0, . . . , N−1} by using ┌log₂(N−1)┐ bits (which is 2 bits when N=4 and 1 bit when N=3), assuming that the lower FD index n₃⁽⁰⁾ (or n₄⁽⁰⁾) (reference for the offset) is 0. The nonzero offset is found from i_{1,6}+1.

Note that the offset Oₗ^{(f)}=(n_{3,l}^{(f)}−n_{3,l}^{(f}^{_{ref}}⁾) or (n_{4,l}^{(f)}−n_{4,l}^{(f}^{_{ref}}⁾) when the FD basis indices are layer-specific, or O^{(f)}=(n₃^{(f)}−n₃^{(f}^{_{ref}}⁾) or (n₄^{(f)}−n₄^{(f}^{_{ref}}⁾) when the FD basis indices are layer-common. When f_{ref}=0 and f∈{0,1} implying
When f=0, the offset Oₗ⁽⁰⁾=O⁽⁰⁾=0.
When f=1, the offset Oₗ⁽¹⁾=(n_{3,l}⁽¹⁾,n_{3,l}⁽⁰⁾) or (n_{4,l}⁽¹⁾,n_{4,l}⁽⁰⁾) when the FD basis indices are layer-specific, or O⁽¹⁾=(n₃⁽¹⁾,n₃⁽⁰⁾) or (n₄⁽¹⁾,n₄⁽⁰⁾) when the FD basis indices are layer-common.

Since Oₗ⁽⁰⁾=O⁽⁰⁾=0, the UE can assume/fix the lower FD index (reference for the offset) is 0 for reporting, i.e., the lower FD index is not (or need not be) reported. That is, only the other offset Oₗ⁽¹⁾ is (or need to be) reported. Note that this is equivalent to example II.1.2.2A. Note also that the phase shift/remapping of FD basis can be up to UE implementation which may remap the FD components so that the lower FD index of W_{f} is assumed to be 0.

In one example (II.1C.2), the lower and higher FD indices of W_{f} are determined such that the lower FD index of W_{f} is 0 and not reported. The higher FD index of W_{f} is nonzero and reported by using ┌log₂(N−1)┐ bits (which is 2 bits when N=4). Note that the phase shift/remapping of FD basis is up to UE implementation which may remap Mᵥ FD components so that the lower FD index of W_{f} is assumed to be 0.

In one embodiment II.2, the UE is configured to report the CSI based on a strongest port indicator (SPI) or reference port indicator (RPI) or port reference for FD index (column of Wf), where the SPI indicates a CSI-RS port index that for example is used in order to determine the FD index (column of Wf) that is the strongest (or that includes the strongest coefficient).

In one example II.2.1, the strongest port indicator (SPI) or reference port indicator (RPI) or reference FD index (column of Wf) is configured, e.g., via higher layer (RRC).

In one example II.2.2, the strongest port indicator (SPI) or reference port indicator (RPI) or reference FD index (column of Wf) is reported by the UE as part of the CSI reporting.
In one example II.2.2.1, the strongest port indicator (SPI) or reference port indicator (RPI) or reference FD index (column of Wf) is the same as (identical to) the SCI (as described in this disclosure). Hence, there is only one reporting for both SCI and SPI.
In one example II.2.2.2, the SCI belongs to (selected or reported from) a set of coefficients with the FD index same as that associated with the SPI. In this case, there are two separate reporting, one for SCI and one for SPI.
   In one example II.2.2.3, the SPI is used to determine the reference FD index (which has the strongest coefficient or tap location at the gNB side), and the UE is configured to use the corresponding FD vector for coefficient calculation/reporting.

In one example II.2.3, when v≥1, the SPI is reported according to at least one of the following examples.
In one example II.2.3.1, the SPI is reported common for all layers l=1, . . . , v, i.e., the SPI remains the same (is common) for all l=1, . . . , v values.
In one example II.2.3.2, the SPI is reported independently for each layer, i.e., the SPI can be different across layers, hence, it is reported for each layer l=1, . . . , v separately (independently).

In one embodiment III.1, for rank v>1, the UE is configured with the codebook parameters L (or K₁) and Mᵥ according to at least one of the following examples.
In one example III.1.1, the values of L (or K₁) and Mᵥ remain the same for all rank values, i.e., they are rank-common, and only value of L (or K₁) and one value of Mᵥ are configured to the UE.
In one example III.1.2, the value of L (or K₁) can be different for different rank values, but the value of Mᵥ remains the same for all rank values. That is, L is rank-specific, and Mᵥ is rank-common.
   For example, L is configured for rank v≤r and L/2 is used for rank v>r, where r=1 or 2.
   For example, (L₁, L₂) are configured, where L₁ for rank v≤r and L₂ for rank v>r, where r=1 or 2.
   For example, one Lᵥ configured for each rank v value.
In one example III.1.3, the value of Mᵥ can be different for different rank values, but the value of L (or K₁) remains the same for all rank values. That is, L is rank-common, and Mᵥ is rank-specific.
   For example, Mᵥ is configured for rank v≤r and

$$\frac{{M}_{υ}}{2} or ⌈ \frac{{M}_{υ}}{2} ⌉ or ⌊ \frac{{M}_{υ}}{2} ⌋$$

is used for rank v>r, where r=1 or 2.
For example, (M_{v,1},M_{v,2}) are configured, where M_{v,1} for rank v≤r and M_{0,2} for rank v>r, where r=1 or 2.
For example, one Mᵥ configured for each rank v value.
For example, Mᵥ=m (configured value) for rank v≤r and Mᵥ=1 for rank v>r, where r=1 or 2.
In one example III.1.4, both L (or K₁) value and Mᵥ value can be different for different rank values. The different L values can be according to at least one example in example III.1.2, and the different Mᵥ values can be according to at least one example in example III.1.3.

In one embodiment III.2, for rank v>1, the UE is configured with the codebook parameters L (or K₁) and Mᵥ as described in embodiment III.1, but some values (e.g., relatively large values) of L (or K₁) or/and Mᵥ are restricted to low rank values.
In one example III.2.1, the restriction is on the L (or K₁) value. For example, a value L>z can only be configured/used for rank v≤r, where r=1 or 2, (hence, it can't be configured for rank v>r). In one example, z=4 or 6 or 8 or 12.
In one example III.2.2, the restriction is on the Mᵥ value. For example, a value Mᵥ>y can only be configured/used for rank v≤r, where r=1 or 2, (hence, it can't be configured for rank v>r). In one example, y=1 or 2 or 3.
In one example III.2.3, the restriction is on both L (or K₁) and Mᵥ values. For example, a value L>z or/and a value Mᵥ>y can only be configured/used for rank v≤r, where r=1 or 2, (hence, they can't be configured for rank v>r). In one example, z=4 or 6 or 8 or 12. In one example, y=1 or 2 or 3.

In one embodiment IV, a UE is configured with higher layer parameter codebookType set to ‘typeII-PortSelection-r17’ for CSI reporting based on a new (Rel. 17) Type II port selection codebook which has a component \tilde{W}₂ for coefficient amplitude/phase reporting (as described in embodiment A.1 and A.2). The component \tilde{W}₂ comprises a total of Z=2LM₁ or K₁M₁ elements/coefficients (2L×M₁ or K₁×M₁ matrix), where M₁=number of FD basis vectors comprising columns of W_{f}, and 2L=K₁=number of ports selected via W₁.

In one example, a subset of the total Z coefficients can be non-zero, and the remaining can be zero. Let Kₗ^{NZ} denote the number of nonzero (NZ) coefficients for layer l=1, . . . , v and K^{NZ}=Σₗ₌₁^{v}Kₗ^{NZ} denote the total number of nonzero coefficients across all layers, where the UE reports the rank indicator (RI) value v, which for example, can be according to (based on) the configured higher layer parameter typeII-RI-Restriction-r17 that configures the set of allowed rank or RI values.

In one example, Kₗ^{NZ} has an upper bound such as Kₗ^{NZ}≤K₀, where K₀ can be fixed or con be configured via higher layer (explicitly or via a parameter). For example, K₀=┌βZ┐, where β≤1. Likewise, K^{NZ} can be upper bounded such as K^{NZ}≤2K₀.

The UE reports an indicator (e.g., indicating a bitmap, similar to R16 Type II codebook) to indicate the location (indices) of the NZ coefficients. Since the locations of NZ coefficients are reported, the UE only needs to report the quantized value (e.g., amplitude/phase) of the NZ coefficients (the remaining coefficients can be set to 0 value). The details about the coefficient quantization is according to at least one of the following embodiments.

In one embodiment IV.1, the amplitude and phase quantization is according to that in Rel. 16 enhanced Type II codebook (cf. Section 5.2.2.2.5, REF8], which is copied below.

The amplitude coefficient indicators i_{2,3,l} and i_{2,4,l} are

i_{2,3,l}=[k_{l,0}⁽¹⁾k_{l,1}⁽¹⁾]

i_{2,4,l}=[k_{l,0}⁽²⁾ . . . k_{l,M}_{ᵥ}₋₁⁽²⁾]

k_{l,k}⁽²⁾=[k_{l,0,f}⁽²⁾ . . . k_{l,2L-1,f}⁽²⁾]

k_{l,p}⁽¹⁾∈{1, . . . ,15}

k_{l,i,f}⁽²⁾∈{0, . . . ,7}

for l=1, . . . , v.

The phase coefficient indicator i_{2,5,l} is

i_{2,5,l}=[c_{l,0} . . . c_{l,M}_{ᵥ}₋₁]

c_{l,f}=[c_{l,0,f} . . . c_{l,2L-1,f}]

c_{l,i,f}∈{0, . . . ,15}

for l=1, . . . , v. The phase coefficient φ_{l,i,f} is given by

$${φ}_{l , i , f} = {e}^{j \frac{2 π {c}_{l , i , f}}{16}} .$$

The bitmap whose nonzero bits identify which coefficients in i_{2,4,l} and i_{2,5,l} are reported, is indicated by i_{1,7,l,}

i_{1,7,l}=[k_{l,0}⁽³⁾ . . . k_{l,M}_{ᵥ}₋₁⁽³⁾]

k_{l,f}⁽³⁾=[k_{l,0,f}⁽³⁾ . . . k_{l,2L-1,f}⁽³⁾]

k_{l,i,f}⁽³⁾∈{0,1}

for l=1, . . . , v, such that Kₗ^{NZ}=Σᵢ₌₀^{2L-1}Σ_{f=0}^{M}^{ᵥ}⁻¹k_{l,i,f}⁽³⁾≤K₀ is the number of nonzero coefficients for layer l=1, . . . , v and K^{NZ}=Σₗ₌₁^{v}Kₗ^{NZ}≤2K₀ is the total number of nonzero coefficients.

The mapping from k_{l,p}⁽¹⁾ to the amplitude coefficient p_{l,p}⁽¹⁾ is given in Table 5.2.2.2.5-2 and the mapping from k_{l,i,f}⁽²⁾ to the amplitude coefficient p_{l,i,f}⁽²⁾ is given in Table 5.2.2.2.5-3. The amplitude coefficients are represented by

pₗ⁽¹⁾=[p_{l,0}⁽¹⁾p_{l,1}⁽¹⁾]

pₗ⁽²⁾=[p_{l,0}⁽²⁾ . . . p_{l,M}_{ᵥ}₋₁⁽²⁾]

p_{l,f}⁽²⁾=[p_{l,0,f}⁽²⁾ . . . p_{l,2L-1,f}⁽²⁾]

for l=1, . . . , v.

Let fₗ*∈{0, 1, . . . , Mᵥ−1} be the index of i_{2,4,l} and iₗ*∈{0, 1, . . . , 2L−1} be the index of k_{l,f}_{ₗ}_{*}⁽²⁾ which identify the strongest coefficient of layer l, i.e., the element k_{l,i}_{ₗ}_{*,f}_{ₗ}_{*}⁽²⁾ of i_{2,4,l}, for l=1, . . . , v. The codebook indices of n_{3,l} are remapped with respect to n_{3,l}^{(f}^{ₗ}^{*)} as n_{3,l}^{(f)}=(n_{3,l}^{(f)}−n_{3,l}^{(f}^{ₗ}_{*)}) mod N₃, such that n_{3,l}^{(f}^{ₗ}_{*)}=0, after remapping. The index f is remapped with respect to fₗ* as f=(f−fₗ*) mod Mᵥ, such that the index of the strongest coefficient is fₗ*=0 (l=1, . . . , v), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0, 1, . . . , 2L−1}, which is obtained as follows

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix} \qquad ( 3 )$$

for l=1, . . . , v.

TABLE 5.2.2.2.5-2
Mapping of elements of i_{2,3,l}:k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , \qquad {k}_{l , {i}_{l}^{*} , 0}^{( 2 )} = 7 , \qquad {k}_{l , {i}_{l}^{*} , 0}^{( 3 )} = 1 and {c}_{l , {i}_{l}^{*} , 0} = 0 \qquad ( l = 1 , … , υ ) .$$

The indicators

$${k}_{l , ⌊ \frac{{i}_{l}^{*}}{L} ⌋}^{( 1 )} ,$$

k_{l,i}_{ᵢ}_{^{*}}_{,0}⁽²⁾ and c_{l,i}_{ₗ}_{*,0} are not reported for l=1, . . . , v.
The indicator

$${k}_{l , ( ⌊ \frac{{i}_{l}^{*}}{L} ⌋ + 1 ) mod 2}^{( 1 )}$$

is reported for l=1, . . . , v.
The K^{NZ}−v indicators k_{l,i,f}⁽²⁾ for which k_{l,i,f}⁽³⁾=1, i≠i*, f≠0 are reported.
The K^{NZ}−v indicators c_{l,i,f} for which k_{l,i,f}⁽³⁾=1, i≠iₗ*, f≠0 are reported.
The remaining Zᵥ·v−K^{NZ} indicators k_{l,i,f}⁽²⁾ are not reported.
The remaining Zᵥ·v−K^{NZ} indicators c_{l,i,f} are not reported.
   Where Zᵥ=2L·Mᵥ or K₁·Mᵥ.

TABLE 5.2.2.2.5-3
Mapping of elements of i_{2,4,l}:k_{l,i,f}⁽²⁾ to p_{l,i,f}⁽²⁾

| k_{l,i,f}⁽²⁾ | p_{l,i,f}⁽²⁾ |
|---|---|
| 0 | $\frac{1}{2 \sqrt{8}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

In one embodiment IV.2, the amplitude and phase quantization of NZ coefficients is according to embodiment IV.1, except that the value k_{l,p}⁽¹⁾=0 which maps to “reserved” (hence, cannot be used) in reference amplitude quantization (cf. Table 5.2.2.2.5-2) is replaced with a new value. At least one of the following examples is used for the new value.
In one example IV.2.1, the new value is

$${( \frac{1}{2} )}^{\frac{3}{8}} .$$

In one example IV.2.2, the new value is from

$$\{ {( \frac{1}{2} )}^{\frac{1}{8}} , {( \frac{1}{2} )}^{\frac{3}{8}} , {( \frac{1}{2} )}^{\frac{5}{8}} , {( \frac{1}{2} )}^{\frac{7}{8}} , {( \frac{1}{2} )}^{\frac{9}{8}} , {( \frac{1}{2} )}^{\frac{11}{8}} , … , \} .$$

In one example IV.2.3, the new value is fixed depending on the rank. For example, a=

$${( \frac{1}{2} )}^{\frac{9}{8}}$$

when rank 1, and

$$a = {( \frac{1}{2} )}^{\frac{3}{8}}$$

when rank 2. In a variation, the value a is reported by the UE. In another variation, the value a is configured to the UE. Also, the reporting or configuration of the value a can be layer-common (one value common for all layers) or layer-independent (one value for each layer).

In one embodiment IV.3, the amplitude and phase quantization of NZ coefficients is according to embodiment IV.1, except that the value k_{l,p}⁽¹⁾=0 which maps to “reserved” (hence, cannot be used) in reference amplitude quantization (cf. Table 5.2.2.2.5-2) is used according to at least one of the following examples.
In one example IV.3.1, the UE is not expected to use this state for amplitude reporting.
In one example IV.3.2, the reserved state can be turned ON by higher layer signaling. When turned on, the UE can use this state for amplitude reporting and the amplitude value that this state indicates belongs to

$$\{ 0 , {( \frac{1}{{2}^{15}} )}^{\frac{1}{4}} , {( \frac{1}{2} )}^{\frac{1}{8}} , {( \frac{1}{2} )}^{\frac{3}{8}} , {( \frac{1}{2} )}^{\frac{5}{8}} , {( \frac{1}{2} )}^{\frac{7}{8}} , {( \frac{1}{2} )}^{\frac{9}{8}} , {( \frac{1}{2} )}^{\frac{11}{8}} , … , \} .$$

In one example IV.3.3, the reserved state can be turned ON depending on UE capability signaling. For example, the UE reports via capability signaling, whether it can support amplitude reporting for this reserved state. When the UE is capable to do so, the UE can use this state for amplitude reporting and the amplitude value that this state indicates belongs to

$$\{ 0 , {( \frac{1}{{2}^{15}} )}^{\frac{1}{4}} , {( \frac{1}{2} )}^{\frac{1}{8}} , {( \frac{1}{2} )}^{\frac{3}{8}} , {( \frac{1}{2} )}^{\frac{5}{8}} , {( \frac{1}{2} )}^{\frac{7}{8}} , {( \frac{1}{2} )}^{\frac{9}{8}} , {( \frac{1}{2} )}^{\frac{11}{8}} , … , \} .$$

In one embodiment IV.4, the amplitude and phase quantization of NZ coefficients is according to embodiment IV.1 or IV.2 or IV.3, except that the strongest coefficient indicator (SCI) i_{1,8,l} is not used in quantization, and instead, the reference amplitude indicator k indicates reference amplitudes for all NZ coefficients. The UE may still report i_{1,8,l}, or, the SCI (i_{1,8,l}) Is not reported. Two reference amplitudes, one for each p value, are reported.

The amplitude and phase coefficient indicators are reported as follows:
The indicator k_{l,p}⁽¹⁾ is reported for l=1, . . . , and p=0, 1.
The K^{NZ} indicators k_{l,i,f}⁽²⁾ for which k_{l,i,f}⁽³⁾=1 are reported.
The K^{NZ} indicators c_{l,i,f} for which k_{l,i,f}⁽³⁾=1 are reported.
The remaining Zᵥ·v−K^{NZ} indicators k_{l,i,f}⁽²⁾ are not reported.
The remaining Zᵥ·v−K^{NZ} indicators c_{l,i,f} are not reported.
   Where Zᵥ=2L·Mᵥ or K₁·Mᵥ.

In one embodiment IV.5, the amplitude and phase quantization of NZ coefficients is according to embodiment IV.1 or IV.2 or IV.3, except that the strongest coefficient indicator (SCI) i_{1,8,l} is not used in quantization, and instead, the reference amplitude indicator k indicates reference amplitudes for all NZ coefficients. The UE may still report i_{1,8,l}, or, the SCI (i_{1,8,l}) Is not reported.

One of two reference amplitudes is fixed (e.g., to 1) and not reported, which corresponds to the stronger reference amplitude (p_{l*}), and a 1-bit indicator is used to report it. The other reference amplitude is reported. The 1-bit indicator can be via i_{1,8,l} (with SCI or without SCI). In one example,

$${p}_{l}^{*} = ⌊ \frac{{i}_{l}^{*}}{L} ⌋ ,$$

which is an index of the strongest coefficient.
The amplitude and phase coefficient indicators are reported as follows:
k_{l,p}_{ₗ}_{*}⁽¹⁾=15 (l=1, . . . , v). The indicators k_{l,p}_{ₗ}_{*}⁽¹⁾ are not reported for l=1, . . . , v.
The indicator k_{l,(p}_{ₗ}_{*+1)mod 2}⁽¹⁾ is reported for l=1, . . . , v.
The K^{NZ} indicators k_{l,i,f}⁽²⁾ for which k_{l,i,f}⁽³⁾=1 are reported.
The K^{NZ} indicators c_{l,i,f} for which k_{l,i,f}⁽³⁾=1 are reported.
The remaining Zᵥ·v−K^{NZ} indicators k_{l,i,f}⁽²⁾ are not reported.
The remaining Zᵥ·v−K^{NZ} indicators c_{l,i,f} are not reported.
   Where Zᵥ=2L·Mᵥ or K₁·Mᵥ.

In one embodiment IV.6, the phase quantization of each NZ coefficient is based on a 2^{N}^{ₚ}−PSK phase codebook. The phase coefficient indicator i_{2,5,l} is

i_{2,5,l}=[c_{l,0} . . . c_{l,M}_{ᵥ}₋₁]

c_{l,f}=[c_{l,0,f} . . . c_{l,2L-1,f}]

c_{l,i,f}∈{0, . . . ,2^{N}^{ₚ}−1}

for l=1, . . . , v. The phase coefficient φ_{l,i,f} is given by

$${φ}_{l , i , f} = {e}^{j \frac{2 π {c}_{l , i , f}}{{2}^{{N}_{p}}}} .$$

In one example, Nₚ is fixed to Nₚ=3 or 4. In one example, Nₚ is configured from {3,4}. When Nₚ=3, 2^{N}^{ₚ}=8 implying that the phase codebook is 8-PSK. When Nₚ=4, 2^{N}^{ₚ}=16 implying that the phase codebook is 16-PSK.

The amplitude quantization of each NZ coefficient is based on a Nₐ-bit codebook. The amplitude coefficient indicators i_{2,4,l} are

i_{2,4,l}=[k_{l,0}⁽²⁾ . . . k_{l,M}_{ᵥ}₋₁⁽²⁾]

k_{l,f}⁽²⁾=[k_{l,0,f}⁽²⁾ . . . k_{l,2L-1,f}⁽²⁾]

k_{l,i,f}⁽²⁾∈{0, . . . ,2^{N}^{ₐ}−1}

for l=1, . . . , v. In one example, Nₐ is fixed to Nₐ=3 or 4. In one example, Nₐ is configured from {3,4}.

The Nₐ-bit codebook is according to at least one of the following examples.

In one example IV.6.1, Nₐ=3, and the amplitude codebook is the 3-bit amplitude codebook for WB amplitude reporting in Rel. 15 Type II codebook [Table 5.2.2.2.3-2 in REF8], copied below.

TABLE 5.2.2.2.3-2

| k_{l, i}⁽¹⁾ | p_{l, i}⁽¹⁾ |
|---|---|
| 0 | 0 |
| 1 | \sqrt{1/64} |
| 2 | \sqrt{1/32} |
| 3 | \sqrt{1/16} |
| 4 | \sqrt{1/8} |
| 5 | \sqrt{1/4} |
| 6 | \sqrt{1/2} |
| 7 | 1 |

In one example IV.6.2, Nₐ=4, and the amplitude codebook is the 4-bit amplitude codebook for reference amplitude reporting in Rel. 16 enhanced Type II codebook [Table 5.2.2.2.5-2 in REF8], copied in embodiment IV.1.

In one example IV.6.3, Nₐ=4, and the amplitude codebook is the 4-bit amplitude codebook for reference amplitude reporting in Rel. 16 enhanced Type II codebook [Table 5.2.2.2.5-2 in REF8], copied in embodiment IV.1, except that the value k=0 which maps to “reserved” (hence, cannot be used) in reference amplitude quantization (cf. Table 5.2.2.2.5-2) is replaced with a new value, where the new value is according to one of the examples in embodiment IV.2.

In one example IV.6.4, Nₐ=3, and the amplitude codebook is a uniform codebook in linear scale between 0 and 1, with a step size

$$s = \frac{1}{{2}^{{N}_{a}}} = \frac{1}{16} .$$

The amplitude codebook A is given by one of the following examples.
In one example, A={0, s, 2s, 3s, . . . , 7s}={0, 1/8, 2/8, 3/8, 4/8, 5/8, 6/8, 7/8}
In one example, A={s, 2s, 3s, . . . , 7s, 8s}={1/8, 2/8, 3/8, 4/8, 5/8, 6/8, 7/8, 1}.

In one example IV.6.5, Nₐ=3, and the amplitude codebook is a uniform codebook in linear scale between 0 and 1, with a step size

$$s = \frac{1}{{2}^{{N}_{a}}} = \frac{1}{8} .$$

The amplitude codebook A is given by A={0, s, 2s, 3s, . . . , 7s}={0, 1/7, 2/7, 3/7, 4/7, 5/7, 6/7, 1}.

In one example IV.6.6, Nₐ=4, and the amplitude codebook is a uniform codebook in linear scale between 0 and 1, with a step size

$$s = \frac{1}{{2}^{{N}_{a}} - 1} = \frac{1}{7} .$$

The amplitude codebook A is given by one of the following examples.
In one example, A={0, s, 2s, 3s, . . . , 15s}={0, 1/16, 2/16, 3/16, . . . , 15/16}.
In one example, A={s, 2s, 3s, . . . , 16s}={1/16, 2/16, 3/16, . . . , 15/16, 1}.

In one example IV.6.7, Nₐ=4, and the amplitude codebook is a uniform codebook in linear scale between 0 and 1, with a step size

$$s = \frac{1}{{2}^{{N}_{a}} - 1} = \frac{1}{15} .$$

The amplitude codebook A is given by A=0{0, s, 2s, 3s, . . . , 7s}={0, 1/15, 2/15, 3/15, . . . , 14/15, 1}.

In one example IV.6.8, the amplitude codebook comprises a squared-root of the amplitude values in example IV.6.4, i.e., a step size

$$s = \sqrt{\frac{1}{{2}^{{N}_{a}}}} = \sqrt{\frac{1}{8}}$$

and the amplitude codebook A is given by one of the following examples.
In one example,

$$A = \{ 0 , s , 2 s , 3 s , … , 7 s \} = \{ 0 , \sqrt{\frac{1}{8}} , \sqrt{\frac{2}{8}} , … , \sqrt{\frac{7}{8}} \}$$

In one example,

$$A = \{ s , 2 s , 3 s , … , 7 s , 8 s \} = \{ \sqrt{\frac{1}{8}} , \sqrt{\frac{2}{8}} , … , \sqrt{\frac{7}{8}} , 1 \} .$$

In one example IV.6.9, the amplitude codebook comprises a squared-root of the amplitude values in example IV.6.5, i.e., a step size

$$s = \sqrt{\frac{1}{{2}^{{N}_{a}} - 1}} = \sqrt{\frac{1}{7}}$$

and the amplitude codebook A is given by

$$A = \{ 0 , s , 2 s , 3 s , … , 7 s \} = \{ 0 , \sqrt{\frac{1}{7}} , \sqrt{\frac{2}{7}} , … , \sqrt{\frac{6}{7}} , 1 \} .$$

In one example IV.6.10, the amplitude codebook comprises a squared-root of the amplitude values in example IV.6.6, i.e., a step size

$$s = \sqrt{\frac{1}{{2}^{{N}_{a}}}} = \sqrt{\frac{1}{16}}$$

and the amplitude codebook A is given by one of the following examples.
In one example,

$$A = \{ 0 , s , 2 s , 3 s , … , 7 s \} = \{ 0 , \sqrt{\frac{1}{16}} , \sqrt{\frac{2}{16}} , … , \sqrt{\frac{15}{16}} \}$$

In one example,

$$A = \{ s , 2 s , 3 s , … , 7 s , 8 s \} = \{ \sqrt{\frac{1}{16}} , \sqrt{\frac{2}{16}} , … , \sqrt{\frac{15}{16}} , 1 \} .$$

In one example IV.6.11, the amplitude codebook comprises a squared-root of the amplitude values in example IV.6.7, i.e., a step size

$$s = \sqrt{\frac{1}{{2}^{{N}_{a}} - 1}} = \sqrt{\frac{1}{15}}$$

and the amplitude codebook A is given by

$$A = \{ 0 , s , 2 s , 3 s , … , 7 s \} = \{ 0 , \sqrt{\frac{1}{15}} , \sqrt{\frac{2}{15}} , … , \sqrt{\frac{14}{15}} , 1 \} .$$

In one embodiment IV.7, the phase quantization is the same as in embodiment IV.6. The amplitude quantization is based on one reference amplitude pₗ⁽¹⁾ (similar to embodiment IV.1 through IV.5) for all NZ coefficients, and the different amplitude p_{l,f}⁽²⁾ (with respect to the reference amplitude) for each NZ coefficients. The quantized amplitude is given by pₗ⁽¹⁾p_{l,f}⁽²⁾. The codebooks for the reference and differential amplitude components are according to example IV.6.x and example IV.6.y, respectively, where (x,y) is according to at least one of the following examples.
In one example IV.7.1, (x,y) is one of (2,1) (2,4), (2,5), (2,8), and (2,9).
In one example IV.7.2, (x,y) is one of (3,1) (3,4), (3,5), (3,8), and (3,9).
In one example IV.7.3, (x,y) is one of (6,1) (6,4), (6,5), (6,8), and (6,9).
In one example IV.7.4, (x,y) is one of (7,1) (7,4), (7,5), (7,8), and (7,9).
In one example IV.7.5, (x,y) is one of (10,1) (10,4), (10,5), (10,8), and (10,9).
In one example IV.7.6, (x,y) is one of (11,1) (11,4), (11,5), (11,8), and (11,9).

In one embodiment IV.8, the phase quantization is the same as in embodiment IV.6. The amplitude quantization is based on two reference amplitudes pₗ⁽¹⁾=[p_{k,0}⁽¹⁾ p_{l,1}⁽¹⁾] (similar to embodiment IV.1 through IV.5) for all NZ coefficients, and the different amplitude p_{l,f}⁽²⁾ (with respect to the reference amplitude) for each NZ coefficients. The quantized amplitude is given by p_{l,p}⁽¹⁾p_{l,f}⁽²⁾. (The codebooks for the reference and differential amplitude components are according to example IV.6.x and example IV.6.y, respectively, where (x,y) is according to at least one of the following examples in example IV.7.1 through IV.7.6.

In one embodiment IV.9, the phase quantization is the same as in embodiment IV.6. The amplitude quantization is based on amplitude codebook that is a mixture of two resolutions (or step sizes). At least one of the following examples is used.
In one example IV.9.1, one half of the amplitude values are selected from [a, 1], and the remaining half of the amplitude values are selected from [0,1]. In one example, a is fixed (e.g., a=⅓ or ¼) or configured.
In one example IV.9.2, N₁ amplitude values are selected from [½,1], and N₂ amplitude values are selected from [0,½], where N₁>N₂. In one example, N₁=⅔ or ¾ of the total number amplitude values (2^{N}^{ₐ}) in the codebook. In one example, N₁ is configured.
In one example IV.9.3, when Nₐ=4, there are 16 amplitude values in total that are selected as follows.
   The 8 amplitude values correspond to:

$${p}_{1} = {( \frac{1}{{x}_{1}} )}^{\frac{1}{8}} ,$$

where x₁=2ⁱ and i=0, 1, . . . , 7.
The 4 amplitude values correspond to:

$${p}_{2} = {( \frac{1}{{x}_{2}} )}^{\frac{1}{4}} ,$$

where x₂=2^{j} and j=4, . . . , 7.
The 4 amplitude values correspond to:

$${p}_{3} = {( \frac{1}{{x}_{3}} )}^{\frac{1}{2}} ,$$

where x₃=₂k and k=4, . . . , 7.
In one example IV.9.4, the amplitude codebook comprises a squared-root of the amplitude values in example IV.9.1.
In one example IV.9.5, the amplitude codebook comprises a squared-root of the amplitude values in example IV.9.2.
In one example IV.9.6, the amplitude codebook comprises a squared-root of the amplitude values in example IV.9.3.

In one embodiment IV.10, the phase quantization is the same as in embodiment IV.6. The amplitude quantization is based on one reference amplitude pₗ⁽¹⁾ (similar to embodiment IV.1 through IV.5) for all NZ coefficients, and the different amplitude p_{l,f}⁽²⁾ (with respect to the reference amplitude) for each NZ coefficients. The quantized amplitude is given by pₗ⁽¹⁾p_{l,f}⁽²⁾. The codebooks for the reference and differential amplitude components are according to example IV.9.x and example IV.6.y, respectively, where (x,y) is according to at least one of the following examples.
In one example IV.10.1, (x,y) is one of (1,1) (2,4), (2,5), (2,8), and (2,9).
In one example IV.10.2, (x,y) is one of (2,1) (2,4), (2,5), (2,8), and (2,9).
In one example IV.10.3, (x,y) is one of (3,1) (3,4), (3,5), (3,8), and (3,9).
In one example IV.10.4, (x,y) is one of (4,1) (4,4), (4,5), (4,8), and (4,9).
In one example IV.10.5, (x,y) is one of (5,1) (5,4), (5,5), (5,8), and (5,9).
In one example IV.10.6, (x,y) is one of (6,1) (6,4), (6,5), (6,8), and (6,9).

In one embodiment IV.11, the phase quantization is the same as in embodiment IV.6. The amplitude quantization is based on two reference amplitudes pₗ⁽¹⁾=[p_{l,0}⁽¹⁾ p_{l,1}⁽¹⁾] (similar to embodiment IV.1 through IV.5) for all NZ coefficients, and the different amplitude p_{l,f}⁽²⁾ (with respect to the reference amplitude) for each NZ coefficients. The quantized amplitude is given by p_{l,p}⁽¹⁾p_{l,f}⁽²⁾. The codebooks for the reference and differential amplitude components are according to example IV.9.x and example IV.6.y, respectively, where (x,y) is according to at least one of the following examples in example IV.10.1 through IV.10.6.

Any of the above variation embodiments can be utilized independently or in combination with at least one other variation embodiment.

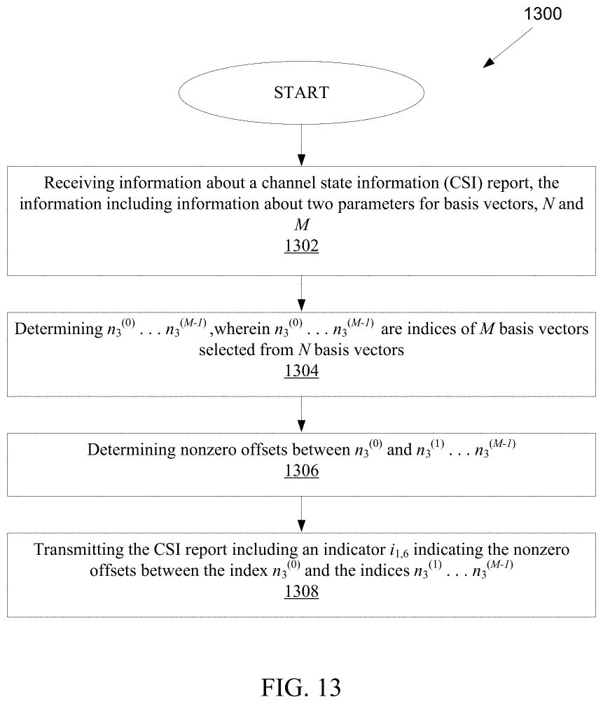

FIG. 13 illustrates a flow chart of a method 1300 for operating a user equipment (UE), as may be performed by a UE such as UE 116, according to embodiments of the present disclosure. The embodiment of the method 1300 illustrated in FIG. 13 is for illustration only. FIG. 13 does not limit the scope of this disclosure to any particular implementation.

As illustrated in FIG. 13, the method 1300 begins at step 1302. In step 1302, the UE (e.g., 111-116 as illustrated in FIG. 1) receives information about a CSI report, the information including information about two parameters for basis vectors, N and M.

In step 1304, the UE determines n₃⁽⁰⁾ . . . n₃^{(M-1)}, wherein n₃⁽⁰⁾ . . . n₃^{(M-1)} are indices of M basis vectors selected from N basis vectors.

In step 1306, the UE determines nonzero offsets between n₃⁽⁰⁾ and n₃^{(1) . . . n}₃^{(M-1)}.

In step 1308, the UE transmits the CSI report including an indicator i_{1,6} indicating the nonzero offsets between n₃⁽⁰⁾ and n₃⁽¹⁾ . . . n₃^{(M-1)}.

In one embodiment, n₃⁽⁰⁾ is a reference for the nonzero offsets and is assumed to be 0.

In one embodiment, M=2, and the indicator i_{1,6} indicates the nonzero offset between n₃⁽⁰⁾ and n₃⁽¹⁾.

In one embodiment, the indicator i_{1,6} is reported using ┌log₂(N−1)┐ bits.

In one embodiment, the nonzero offset between n₃⁽⁰⁾ and n₃⁽¹⁾ corresponds to n₃⁽¹⁾−n₃⁽⁰⁾.

In one embodiment, the CSI report includes, for each layer l, an indicator (i_{1,8,l}) indicating indices (iₗ*,fₗ*) of a strongest coefficient, where i_{1,8,l}=K₁fₗ*+iₗ*, where K₁ is a number of selected CSI reference signal (CSI-RS) ports from a total of P CSI-RS ports configured for the CSI report, and l∈{1, . . . , v}, where v is a rank value associated with the CSI report.

In one embodiment, i_{1,8,l}∈{0, 1, . . . , K₁M−1}, iₗ*∈{0, 1, . . . , K₁−1} and fₗ*∈{0, . . . , M−1}

In one embodiment, the indicator i_{1,8,l} is reported using ┌log₂(K₁M)┐ bits for each l∈{1, . . . , v}.

FIG. 14 illustrates a flow chart of another method 1400, as may be performed by a base station (BS) such as BS 102, according to embodiments of the present disclosure. The embodiment of the method 1400 illustrated in FIG. 14 is for illustration only. FIG. 14 does not limit the scope of this disclosure to any particular implementation.

As illustrated in FIG. 14, the method 1400 begins at step 1402. In step 1402, the BS (e.g., 101-103 as illustrated in FIG. 1), generates information about a channel state information (CSI) report, the information including information about two parameters for basis vectors, N and M.

In step 1404, the BS transmits the information.

In step 1406, the BS receives the CSI report; wherein the CSI report includes an indicator i_{1,6} indicating nonzero offsets between n₃⁽⁰⁾ and n₃⁽¹⁾ . . . n₃^{(M-1)}, wherein n₃⁽⁰⁾ . . . n₃^{(M-1)} are indices of M basis vectors selected from N basis vectors.

In one embodiment, n₃⁽⁰⁾ is a reference for the nonzero offsets and is assumed to be 0.

In one embodiment, M=2, and the indicator i_{1,6} indicates the nonzero offset between n₃⁽⁰⁾ and n₃⁽¹⁾.

In one embodiment, the indicator i_{1,6} is reported using ┌log₂(N−1)┐ bits.

In one embodiment, the nonzero offset between n₃⁽⁰⁾ and n₃⁽¹⁾ corresponds to n₃⁽¹⁾−n₃⁽⁰⁾.

In one embodiment, the CSI report includes, for each layer l, an indicator (i_{1,8,l}) indicating indices (iₗ*,fₗ*) of a strongest coefficient, where i_{1,8,l}=K₁fₗ*+iₗ*, where K₁ is a number of selected CSI reference signal (CSI-RS) ports from a total of P CSI-RS ports configured for the CSI report, and l∈{1, . . . , v}, where v is a rank value associated with the CSI report.

In one embodiment, i_{1,8,l}∈{0, 1, . . . , K₁M−1}, iₗ*∈{0, 1, . . . , K₁−1} and fₗ*∈{0, . . . , M−1}

In one embodiment, the indicator i_{1,8,l} is reported using ┌log₂(K₁M)┐ bits for each l∈{1, . . . , v}.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report, the information including information about two parameters for basis vectors, N and M; and
a processor operably coupled to the transceiver, the processor, based on the information, configured to:
determine n₃⁽⁰⁾ . . . n₃^{(M-1)}, wherein n₃⁽⁰⁾ . . . n₃^{(M-1)} are indices of M basis vectors selected from N basis vectors, and
determine nonzero offsets between index n₃⁽⁰⁾ and indices n₃⁽¹⁾ . . . n₃^{(M-1)},
wherein the transceiver is further configured to transmit the CSI report including an indicator i_{1,6} indicating the nonzero offsets between the index n₃⁽⁰⁾ and the indices n₃⁽¹⁾ . . . n₃^{(M-1)}.

2. The UE of claim 1, wherein n₃⁽⁰⁾ is a reference for the nonzero offsets and is assumed to be 0.

3. The UE of claim 1, wherein:
M=2, and
the indicator i_{1,6} indicates the nonzero offset between n₃⁽⁰⁾ and n₃⁽¹⁾.

4. The UE of claim 3, wherein the indicator i_{1,6} is reported using ┌log₂(N−1)┐ bits.

5. The UE of claim 3, wherein the nonzero offset between n₃⁽⁰⁾ and n₃⁽¹⁾ corresponds to n₃⁽¹⁾−n₃⁽⁰⁾.

6. The UE of claim 1, wherein: the CSI report includes, for each layer l, an indicator (i_{1,8,l}) indicating indices (iₗ*,fₗ*) of a strongest coefficient, where i_{1,8,l}=K₁fₗi*+iₗ*, where K₁ is a number of selected CSI reference signal (CSI-RS) ports from a total of P CSI-RS ports configured for the CSI report, and l∈{1, . . . , v}, where v is a rank value associated with the CSI report.

7. The UE of claim 6, wherein:
i_{1,8,l}∈{0, 1, . . . , K₁M−1},
iₗ*∈{0, 1, . . . , K₁−1}, and
fₗ*∈{0, . . . , M−1}

8. The UE of claim 6, wherein the indicator i_{1,8,l} is reported using ┌log₂(K₁M)┐ bits for each l∈{1, . . . , v}.

9. A base station (BS) comprising:
a processor configured to:
generate information about a channel state information (CSI) report, the information including information about two parameters for basis vectors, N and M; and
a transceiver operably coupled to the processor, the transceiver configured to:
transmit the information; and
receive the CSI report,
wherein the CSI report includes an indicator i_{1,6} indicating nonzero offsets between n₃⁽⁰⁾ . . . n₃^{(M-1)}, wherein n₃⁽⁰⁾ . . . n₃^{(M-1)} are indices of M basis vectors selected from N basis vectors.

10. The BS of claim 9, wherein n₃⁽⁰⁾ is a reference for the nonzero offsets and is assumed to be 0.

11. The BS of claim 9, wherein:
M=2, and
the indicator i_{1,6} indicates the nonzero offset between n₃⁽⁰⁾ and n₃⁽¹⁾.

12. The BS of claim 11, wherein the indicator i_{1,6} is reported using ┌log₂(N−1)┐ bits.

13. The BS of claim 11, wherein the nonzero offset between n₃⁽⁰⁾ and n₃⁽¹⁾ corresponds to n₃⁽¹⁾−n₃⁽⁰⁾.

14. The BS of claim 9, wherein: the CSI report includes, for each layer l, an indicator (i_{1,8,l}) indicating indices (iₗ*, fₗ*) of a strongest coefficient, where i_{1,8,l}=K₁fₗ*+iₗ*, where K₁ is a number of selected CSI reference signal (CSI-RS) ports from a total of P CSI-RS ports configured for the CSI report, and l∈{1, . . . , v}, where v is a rank value associated with the CSI report.

15. The BS of claim 14, wherein:
i_{1,8,l}∈{0, 1, . . . , K₁M−1},
iₗ*∈{0, 1, . . . , K₁−1}, and
fₗ*∈{0, . . . , M−1}

16. The BS of claim 14, wherein the indicator i_{1,8,l} is reported using ┌log₂(K₁M)┐ bits for each l∈{1, . . . , v}.

17. A method for operating a user equipment (UE), the method comprising:
receiving information about a channel state information (CSI) report, the information including information about two parameters for basis vectors, N and M;
determining n₃⁽⁰⁾ . . . n₃^{(M-1)}, wherein n₃⁽⁰⁾ . . . n₃^{(M-1)} are indices of M basis vectors selected from N basis vectors;
determining nonzero offsets between index n₃⁽⁰⁾ and indices n₃⁽¹⁾ . . . n₃^{(M-1)}; and
transmitting the CSI report including an indicator i_{1,6} indicating the nonzero offsets between the index n₃⁽⁰⁾ and the indices n₃⁽¹⁾ . . . n₃^{(M-1)}.

18. The method of claim 17, wherein n₃⁽⁰⁾ is a reference for the nonzero offsets and is assumed to be 0.

19. The method of claim 17, wherein:
M=2, and
the indicator i_{1,6} indicates the nonzero offset between n₃⁽⁰⁾ and n₃⁽¹⁾.

20. The UE of claim 19, further comprising reporting the indicator i_{1,6} using ┌log₂(N−1)┐ bits.
